(19) United States
(12) Patent Application Publication
(10) Pub. No.: US 2011/0137477 A1
(43) Pub. Date: Jun. 9, 2011

(54) ADAPTIVE CONTROL OF A CONCENTRATED SOLAR POWER PLANT

(76) Inventor: Wael Faisal Al-Mazeedi, Lexington, MA (US)

(21) Appl. No.: 12/941,893

(22) Filed: Nov. 8, 2010

Related U.S. Application Data
(63) Continuation of application No. 12/917,250, filed on Nov. 1, 2010.
(60) Provisional application No. 61/258,139, filed on Nov. 4, 2009.
(60) Provisional application No. 61/256,493, filed on Oct. 30, 2009.

(51) Int. Cl. G06F 1/26

(52) U.S. Cl. 700/287

(57) ABSTRACT

A solar-fossil-fuel hybrid power plant is controlled using thermal energy processing component thermal inertia characteristic data and atmospheric condition prediction information to adjust plant operations at a point in time that enables the plant to operate within a predetermined requirement when the plant experiences the predicted atmospheric condition.

### CROSS-REFERENCE TO RELATED APPLICATIONS

This application is a continuation of U.S. Ser. No. 12/917,250 filed Nov. 1, 2010 which claims the benefit of the following provisional applications, each of which is hereby incorporated by reference in its entirety:

U.S. Ser. No. 61/256,493 filed Oct. 30, 2009; and U.S. Ser. No. 61/258,139 filed Nov. 4, 2009.

### BACKGROUND

1. Field

The methods and systems of the invention disclosed herein generally relate to improvements of a solar and fossil fuel hybrid combined cycle power plant.

2. Description of the Related Art

An integrated solar combined cycle plant is one that generally combines the use of concentrated solar collection and fossil fuel power generation. While combining sources of energy for electricity generating power plants has been a concept gaining some traction, there is a real need to understand and improve the systems used to combine the related technologies to achieve the greatest benefit.

### SUMMARY

Combining concentrating solar power with fossil fuel power plant technologies holds much promise; however, optimizing the integration of the two power sources is still required. Aspects of the invention relate to configuration of the solar power block with the fossil fuel power block. As you will see, certain configurations take advantage of lower vapor or fluid temperatures and/or pressures while other embodiments take advantage of higher vapor or fluid temperatures and/or pressures. Certain embodiments will illustrate the advantages of using controllable supplemental heat in the configuration to accommodate changes in the vapor and/or fluid streams as variability in introduced (e.g. as the sun goes down, as the sun comes up, as ambient temperatures change, etc.).

Aspects of the invention further relate to conservation and/or reclamation of water from the power generation system. In addition to the increasing worldwide needs for water, many hybrid power systems are located in areas of the world where water is scarce and the water conservation and reclamation techniques described here in can be used to reduce the hybrid power plants water requirements. In certain embodiments, the hybrid power systems are used in conjunction with desalination or water cleaning systems for the production of clean water.

Aspects of the invention relate to controlling the hybrid power systems. Hybrid power systems are very complex and benefit from a control system that can actively manage the various aspects of the hybrid system. The hybrid power system is made up of many components that generate or control hot fluids and vapors and many of the components require time to stabilize and become effective in the system. While this may be adequate for a hybrid power system operating in a steady state mode, it is not effective or efficient while the hybrid system is in start-up mode, turn-down mode, or suffering from some introduced variability during operation. To optimize the performance during such events, and during other periods, a hybrid system in accordance with the principles of the present invention may have a stored knowledge of each critical component in the hybrid system along with an indication of the thermal inertial characteristics of each critical component and the control system may draw on this knowledge such that the control system can manage the components optimally. In addition, in certain embodiments, the hybrid power control system may have a learning engine. The learning engine may track and interpret performance of the hybrid power system and its components and based on its interpretations, it may modify the control system's understanding of how the hybrid plant, its components, and/or combinations of certain components act and react in certain circumstances. This new learned behavior may then be used to control the hybrid power plant in an optimal way.

Methods and systems may include a method of reclaiming water from a solar-fossil-fuel hybrid power plant comprising: receiving concentrated solar power (CSP) thermal energy from a concentrated solar power field; feeding the CSP thermal into a heat recovery steam generator (HRSG); causing the heat recovery steam generator (HRSG) to receive thermal energy from waste heat, the waste heat being produced by a gas combustion process driving a gas turbine; causing the HRSG to use the CSP thermal energy and the waste heat to produce steam, the steam being utilized to drive a steam generator; recovering vapor from the steam generator; condensing the vapor using an air cooled condenser to form water; feeding the water into a water reclamation exchange adapted to condense exhaust vapor from a gas combustion exhaust system to form exhaust water; and collecting and cleaning the exhaust water.

The methods and systems may include a method of storing in a database a plurality of operational rules governing reclaiming water from the solar-fossil-fuel hybrid power plant in which predefined atmospheric conditions are predicted to occur in proximity to the solar-fossil-fuel hybrid power plant; receiving atmospheric condition prediction information relating to an atmospheric event; retrieving an operational rule from the plurality of operational rules that relates to the atmospheric event; and controlling an aspect of the solar-fossil-fuel hybrid power plant in accordance with the retrieved operational rule.

The methods and systems may include a method of storing in a database a plurality of operational rules governing reclaiming water from the solar-fossil-fuel hybrid power plant in which predefined atmospheric conditions are predicted to occur in proximity to the solar-fossil-fuel hybrid power plant; operating the solar-fossil-fuel hybrid power plant by a selected operational rule, from the plurality of operational rules, in accordance with the predicted atmospheric event; causing a learning system to monitor a performance aspect of the solar-fossil-fuel hybrid power plant during its operation in accordance with the selected operational rule during the predicted atmospheric event; and causing the learning system to modify the selected operational rule based on a learned behavior determined in response to the monitoring step. The feeding of the CSP thermal energy into the heat recovery steam generator (HRSG) may include directing a first portion of steam turbine drive working fluid from an economizer of the heat recovery steam generator (HRSG) to the concentrated solar power field, the steam turbine drive working fluid capable of driving the steam turbine; directing a second portion of the steam turbine drive working fluid from the economizer of the heat recovery steam generator (HRSG) to a steam boiler; causing the concentrated solar power field to heat the first portion of the steam turbine drive working fluid to a predefined temperature and pressure; and causing the first portion of the steam turbine drive working fluid to be combined with the second portion of the steam turbine drive working fluid at an inlet portion of the concentrated solar power field into the steam boiler. Alternatively, the methods and systems may include causing a supplemental fossil fuel generated heat to be added to the heat recovery steam generator (HRSG) such that temperature of the steam produced by the heat recovery steam generator (HRSG) is maintained within an inlet operating tolerance of the steam generator, the supplemental fossil fuel generated heat being added to the heat recovery steam generator (HRSG) if the CSP thermal energy contribution to the heat recovery steam generator (HRSG) falls below a predetermined threshold.

Alternatively, the methods and systems may include a method of increasing power generation efficiency of a solar-fossil-fuel-hybrid power plant, including: directing a first portion of a steam turbine drive working fluid from an economizer of a heat recovery steam generator (HRSG) of the solar-fossil-fuel hybrid power plant into a concentrated solar power (“CSP”) field; directing a second portion of the steam turbine drive working fluid from the economizer to a steam boiler; causing the CSP field to heat the first portion of the steam turbine drive working fluid to a predefined temperature and pressure above that which is in a CSP inlet to the steam boiler; and causing the first portion of the steam turbine drive working fluid to be combined with the second portion of the working fluid at the inlet. The methods and systems may further include feeding steam generated by the steam boiler of the HRSG to a second CSP field; causing the second CSP field to superheat the steam resulting in the formation of superheated steam; and directing the superheated steam from the second CSP field to a steam generator to drive a steam turbine. Alternatively, the methods and systems may further include causing a supplemental fossil fuel generated heat to be added to the HRSG such that temperature of steam produced by the HRSG is maintained within an inlet operating tolerance of the steam boiler, the supplemental fossil fuel generated heat being added if a CSP thermal energy contribution to the HRSG falls below a predetermined threshold. The methods and systems may include a method of increasing power generation efficiency of a solar-fossil-fuel-hybrid power plant may further include a method of storing in a database a plurality of operational rules governing increasing power generation efficiency of the solar-fossil-fuel hybrid power plant in which predefined atmospheric conditions are predicted to occur in proximity to the solar-fossil-fuel hybrid power plant; receiving atmospheric condition prediction information relating to an atmospheric event; retrieving an operational rule from the plurality of operational rules that relates to the atmospheric event; and controlling an aspect of the solar-fossil-fuel hybrid power plant in accordance with the retrieved operational rule. Alternatively, the methods and systems may further include a method of storing in a database a plurality of operational rules governing increasing power generation efficiency of the solar-fossil-fuel hybrid power plant in which predefined atmospheric conditions are predicted to occur in proximity to the solar-fossil-fuel hybrid power plant; operating the solar-fossil-fuel hybrid power plant by a selected operational rule, from the plurality of operational rules, in accordance with the predicted atmospheric event; causing a learning system to monitor a performance aspect of the solar-fossil-fuel hybrid power plant during its operation in accordance with the selected operational rule during the predicted atmospheric event; and causing the learning system to modify the selected operational rule based on a learned behavior determined in response to the monitoring step.

Alternatively, methods and systems may include a method of supplying supplemental superheated steam to a steam turbine in a solar-fossil-fuel hybrid power plant, including: feeding steam from a boiler portion of a heat recovery steam generator (HRSG) of the solar-fossil-fuel hybrid power plant to a concentrated solar power (CSP) field; causing the CSP field to superheat the steam resulting in the formation of superheated steam; and directing the superheated steam from the CSP field to a steam generator to drive the steam turbine.

Method of supplying supplemental superheated steam to a steam turbine in a solar-fossil-fuel hybrid power plant may also include storing in a database a plurality of operational rules governing supplying supplemental superheated steam to a steam turbine in the solar-fossil-fuel hybrid power plant in which predefined atmospheric conditions are predicted to occur in proximity to the solar-fossil-fuel hybrid power plant; receiving atmospheric condition prediction information relating to an atmospheric event; retrieving an operational rule from the plurality of operational rules that relates to the atmospheric event; and controlling an aspect of the solar-fossil-fuel hybrid power plant in accordance with the retrieved operational rule. The method of supplying supplemental superheated steam to a steam turbine in a solar-fossil-fuel hybrid power plant may further include storing in a database a plurality of operational rules governing supplying supplemental superheated steam to a steam turbine in the solar-fossil-fuel hybrid power plant in which predefined atmospheric conditions are predicted to occur in proximity to the solar-fossil-fuel hybrid power plant; operating the solar-fossil-fuel hybrid power plant by a selected operational rule, from the plurality of operational rules, in accordance with the predicted atmospheric event; causing a learning system to monitor a performance aspect of the solar-fossil-fuel hybrid power plant during its operation in accordance with the selected operational rule during the predicted atmospheric event; and causing the learning system to modify the selected operational rule based on a learned behavior determined in response to the monitoring step.

In another aspect of the methods and systems described herein, a method of controlling a solar-fossil-fuel hybrid power plant may include: receiving concentrated solar power (CSP) thermal energy from a concentrated solar power (CSP) field; feeding the CSP thermal energy into a heat recovery steam generator (HRSG); causing the heat recovery steam generator (HRSG) to receive waste heat thermal energy from waste heat produced by a gas combustion process, the gas combustion process used for driving a gas turbine; causing the heat recovery steam generator (HRSG) to use the CSP thermal energy and the waste heat thermal energy to produce steam to drive a steam generator; and causing a supplemental fossil fuel generated heat to be added to the heat recovery steam generator (HRSG) such that temperature of steam produced by the heat recovery steam generator (HRSG) is maintained within an inlet operating tolerance of the steam generator, the supplemental fossil fuel generated heat being added to the heat recovery steam generator (HRSG) if the CSP thermal energy contribution to the heat recovery steam generator (HRSG) falls below a predetermined threshold. The method of controlling a solar-fossil-fuel hybrid power plant may also include storing in a database a plurality of operational rules governing the solar-fossil-fuel hybrid power plant operation of adding supplemental fossil fuel generated heat to the HRSG in which predefined atmospheric conditions are predicted to occur in proximity to the solar-fossil-fuel hybrid power plant; receiving atmospheric condition prediction information relating to an atmospheric event; retrieving an operational rule from the plurality of operational rules that relates to the atmospheric event; and controlling an aspect of the solar-fossil-fuel hybrid power plant in accordance with the retrieved operational rule.

The method of controlling a solar-fossil-fuel hybrid power plant may also include: storing in a database a plurality of operational rules governing the solar-fossil-fuel hybrid power plant operation of adding supplemental fossil fuel generated heat to the HRSG in which predefined atmospheric conditions are predicted to occur in proximity to the solar-fossil-fuel hybrid power plant; operating the solar-fossil-fuel hybrid power plant by a selected operational rule, from the plurality of operational rules, in accordance with the predicted atmospheric event; causing a learning system to monitor a performance aspect of the solar-fossil-fuel hybrid power plant during its operation in accordance with the selected operational rule during the predicted atmospheric event; and causing the learning system to modify the selected operational rule based on a learned behavior determined in response to the monitoring step.

Yet alternatively, methods and systems described herein may include a method of controlling a solar-fossil-fuel hybrid power plant, including: storing a thermal inertia characteristic relating to each of a plurality of thermal energy processing components used in the solar-fossil-fuel hybrid power plant in a database; receiving atmospheric condition prediction information relating to an atmospheric event, the atmospheric condition prediction information indicating that at least one of the plurality of thermal energy processing components requires adjustment such that the solar-fossil-fuel hybrid power plant performs within pre-determined requirements during the atmospheric event; retrieving a thermal inertia characteristic relating to the at least one of the plurality of thermal energy processing components from the database; and causing the at least one of the plurality of thermal energy processing components to be adjusted based on the retrieved thermal inertia characteristic at a point in time that enables the solar-fossil-fuel hybrid power plant to operate within the pre-determined requirements during the atmospheric event.

The methods and systems of power plant control may include a method for controlling an aspect of a solar-fossil-fuel hybrid power plant, including: storing in a database a plurality of operational rules governing operation of the solar-fossil-fuel hybrid power plant in which predefined atmospheric conditions are predicted to occur in proximity to the solar-fossil-fuel hybrid power plant; receiving atmospheric condition prediction information relating to an atmospheric event; retrieving an operational rule from the plurality of operational rules that relates to the atmospheric event; and controlling an aspect of the solar-fossil-fuel hybrid power plant in accordance with the retrieved operational rule.

The methods and systems described herein may alternatively include a method of controlling a solar-fossil-fuel hybrid power plant, including: storing in a database a plurality of operational rules governing operation of the solar-fossil-fuel hybrid power plant in which predefined atmospheric conditions are predicted to occur in proximity to the solar-fossil-fuel hybrid power plant; operating the solar-fossil-fuel hybrid power plant by a selected operational rule, from the plurality of operational rules, in accordance with the predicted atmospheric event; causing a learning system to monitor a performance aspect of the solar-fossil-fuel hybrid power plant during its operation in accordance with the selected operational rule during the predicted atmospheric event; and causing the learning system to modify the selected operational rule based on a learned behavior determined in response to the monitoring step.

A method of controlling a concentrated solar power (CSP) plant, may include: storing a thermal inertia characteristic relating to each of a plurality of thermal energy processing components used in the CSP plant in a database; receiving atmospheric condition prediction information relating to an atmospheric event, the atmospheric condition prediction information indicating that at least one of the plurality of thermal energy processing components requires adjustment such that the CSP plant performs within pre-determined requirements during the atmospheric event; retrieving a thermal inertia characteristic relating to the at least one of the plurality of thermal energy processing components from the database; and causing the at least one of the plurality of thermal energy processing components to be adjusted based on the retrieved thermal inertia characteristic at a point in time that enables the CSP plant to operate within the pre-determined requirements during the atmospheric event.

An alternative method of controlling a concentrated solar power (CSP) plant, may include: storing in a database a plurality of operational rules governing operation of the CSP plant in which predefined atmospheric conditions are predicted to occur in proximity to the CSP plant; receiving atmospheric condition prediction information relating to the atmospheric event; retrieving an operational rule from the plurality of operational rules that relates to the atmospheric event; and controlling an aspect of the CSP plant in accordance with the retrieved operational rule. The aspect of the CSP plant may relate to a short term thermal storage facility or a long term thermal storage facility.

Another method of controlling a concentrated solar power (CSP) plant, may include: storing in a database a plurality of operational rules governing operation of the CSP plant in which predefined atmospheric conditions are predicted to occur in proximity to the CSP plant; operating the CSP plant by a selected operational rule, from the plurality of operational rules, in accordance with the predicted atmospheric event; causing a learning system to monitor a performance aspect of the CSP plant during its operation in accordance with the selected operational rule during the predicted atmospheric event; and causing the learning system to modify the selected operational rule based on a learned behavior determined in response to the monitoring step. The operational rule may relate to a short term thermal storage facility or a long term thermal storage facility.

In yet another alternative method, a method of water reclamation in a supplemental direct solar super-heated steam solar-fossil-fuel hybrid power plant, may include: causing a heat recovery steam generator (HRSG) of the solar-fossil-fuel hybrid power plant to receive waste heat thermal energy from waste heat produced by a gas combustion process driving a gas turbine; causing the HRSG to use the waste heat to produce steam to drive a steam generator; feeding steam from a boiler portion of the HRSG into a concentrated solar power (CSP) field; causing the CSP field to super heat the steam resulting in the formation of superheated steam; directing the super-heated steam from the CSP field to the steam generator to drive a steam turbine; recovering vapor from the steam generator; condensing the vapor using an air cooled condenser to form water; feeding the water into a water reclamation exchange adapted to condense exhaust vapor from a gas combustion exhaust system to form exhaust water; and collecting and cleaning the exhaust water for use.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a schematic view of a water supply system in a hybrid power plant.

FIG. 2 depicts a desalination embodiment of a hybrid power plant.

FIG. 3 direct solar use alternate embodiment of the hybrid power plant depicted in FIG. 1.

FIG. 4 depicts an alternate direct solar embodiment of a hybrid power plant.

FIG. 5 depicts a hybrid power plant with supplemental heating capacity to accommodate variations in solar feedwater heating

FIG. 6 depicts control systems for a hybrid power plant.

FIG. 7 depicts a flow chart for control of a hybrid power plant in response to predicted atmospheric conditions using component characterization information.

FIG. 8 depicts a flow chart for control of a hybrid power plant using operational rules based on predicted atmospheric conditions.

FIG. 9 depicts a flow chart for control of a hybrid power plant using a learning system.

FIG. 10 depicts control of a concentrated solar power plant.

FIG. 11 depicts control of a concentrated solar power plant based on component characterization information.

FIG. 12 depicts a flow chart for a process of controlling a concentrated solar power plant based on component characterization information in response to predicted atmospheric conditions.

FIG. 13 depicts control of a concentrated solar power plant based on operational rules.

FIG. 14 depicts a flow chart for a process of controlling a concentrated solar power plant based on operational rules in response to predicted atmospheric conditions.

FIG. 15 depicts control of a concentrated solar power plant using a learning system.

FIG. 16 depicts a flow chart for a process of controlling a concentrated solar power plant using a learning system.

FIG. 17 depicts a control system of a coal-fired concentrating solar-power-enabled power plant.

FIG. 18 depicts a block diagram of a conventional Rankine power plant.

FIG. 19 depicts a block diagram of an integrated solar-Rankine cycle power plant with solar power based feedwater pre-heating.

FIG. 20 depicts a block diagram of an integrated solar-Rankine cycle power plant with a solar boiler.

### DETAILED DESCRIPTION

In accordance with the principles of the present invention, there are a number of types of hybrid power plants. There are hybrid power plants that combine concentrated solar with: simple cycle gas fired turbine plants; coal fired steam turbine plants, combine cycle plants (i.e a power plant that includes a gas fired turbine and then uses the waste heat from the gas fired turbine to generate heat to be used in the generation of steam for a steam turbine), etc. We will explain certain, but not all, hybrid configurations below. Some of the hybrid configurations will be explained in more detail than others, this is for simplicity sake and should not be construed as limiting the inventions based on the depth of explanation. We will start with an explanation of a hybrid plant that includes a combined cycle fossil fuel power block. Then we will describe water reclamation techniques that may be used in the hybrid system. Then we will generally describe other hybrid configurations (e.g. using only a steam generating power block, using a simple cycle gas fired power block in combination with a steam generated process, a hybrid system in combination with a desalination and/or water cleaning facility.)

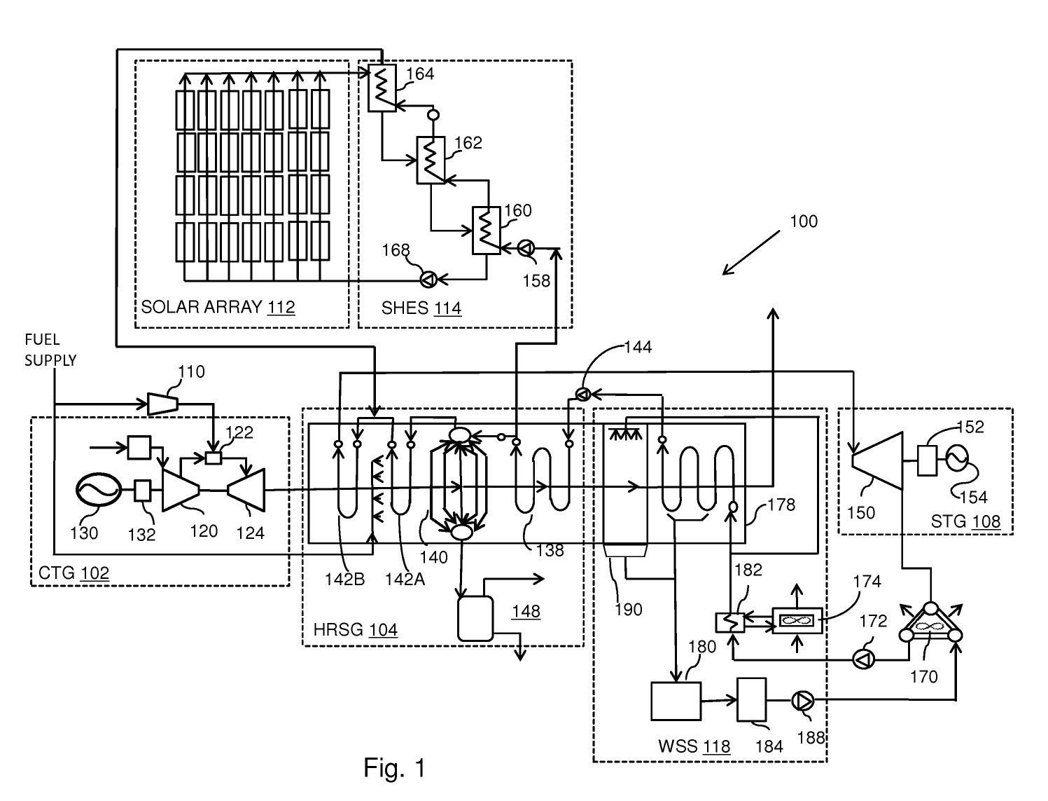

FIG. 1 depicts an overview of a hybrid power plant 100. The hybrid power plant 100 depicted in FIG. 1 includes a Combustion Turbine Generator (CTG) facility 102, a Heat Recovery Steam Generator (HRSG) facility 104, a Steam Turbine Generator (STG) facility 108, a steam condenser facility 110, a concentrated solar production facility (e.g. a parabolic trough solar array 112, as shown, a central tower facility, a Frensel solar array facility, a solar dish facility, etc.), a Solar Heat Exchange System (SHES) facility 114, and a water supply system (WSS) 118. It should be noted that the hybrid power plant 100 may include other components as known in the art, without deviating from the scope of the invention. One such example is a solar collection tower and reflector field may be used instead of or in combination with the parabolic trough solar array 112.

Exemplary functions and operation of the hybrid power plant 100 functional blocks depicted in FIG. 1 are now described to facilitate an understanding of the workings of a hybrid power plant 100. Each functional block or facility is generally referred to by its acronym that corresponds to the summary above and to the annotations on FIG. 1.

A CTG 102 facility may be utilized to generate superheated compressed air for generating steam in an HRSG 104. The CTG facility 102 may operate on the principle of the ‘Brayton cycle’ to generate the superheated compressed air. Thus, the CTG facility 102 may include a compressor 120 to compress air drawn through an inlet air filter, a combustor 122 that may add a combustible fuel to the compressed air and ignite it causing the compressed air to heat, and a turbine 124 to extract power from the hot air flow. The compressor 120, combustor 122 and the turbine 124 may together form an integral part of the CTG 102 and may be referred to as combustion turbine 128. The following general description of combustion turbine 128 operation is for illustrative purposes only.

The CTG compressor 120 may obtain air through an inlet air filter and may compress it isentropically. Isentropy is a process during which the entropy of the system remains constant. As depicted in FIG. 1, the CTG combustion turbine 128 may be attached to a generator 130 through a reduction gear 132 at the ‘cold’ or input end of the combustion turbine 128. The reduction gear 132 reduces the output of the generator 130 to control the input of the compressor 120. However, not all CTG 102 embodiments have the generator connection on the cold end. Many CTG 102 configurations have the generator 130 connected to the turbine 124. A CTG 102 may connect the compressor 120 and the turbine 124 with a common shaft. However, some turbines (e.g. aeroderivative turbines) aerodynamically connect the compressor 120 and turbine 124 in a manner similar to an automatic transmission in an automobile. Also, larger CTGs can operate the generator 130 and compressor 120 synchronously and do not use reduction gears. In general for these configurations, the compressed air produced by the compressor 120 may pass through the combustion chamber, where fuel is introduced and ignited to heat up the compressed air. The fuel in the combustion chamber may be obtained through a fuel supply using a fuel-to-gas compressor. The combustion chamber heats up the air at a constant pressure in an isobaric process. The heated and the compressed air may then pass through a turbine or a set of turbines in which the air expands, delivering energy to the turbine and becoming an exhaust gas. This process is again isentropic. Referring to FIG. 1, the arrowed line in the CTG facility 102 denotes an air and combustion flow associated with the above described process.

Further, since neither the compression of the inlet air nor the expansion of the heated compressed air can be truly isentropic, losses in the compressor and the turbine represent sources of unavoidable working inefficiencies. Therefore, techniques may be used to increase the efficiency or output of the CTG 102. Three examples of energy efficiency improvement techniques are now described.

Regeneration: A regeneration process may involve the installation of a heat exchanger (a recuperator) through which the turbine 124 exhaust gases may pass. The compressed air exiting the compressor 120 may be heated by passing it through the exhaust gas heat exchanger before entering the combustor.

Intercooling: Intercooling may involve the use of a heat exchanger to cool the air and reduce the energy needed to compress the air for use in the combustion chamber. In embodiments, the CTG compressor 120 may consist of a low pressure unit in series with a high pressure unit. An intercooler could be mounted between the low and high pressure units to cool the compressed flow and decrease the work necessary for compression in the high pressure unit. The cooling fluid used to extract heat from the compressed flow may be atmospheric air or water. Intercooling may also be used with the fuel gas compressor 110 of the CTG 102.

Reheating: Reheating of the heated compressed air in a serial multi-turbine configuration after it has passed through a first turbine may increase efficiency of the second turbine. In an example, a CTG 102 may have a high pressure turbine followed by a low pressure turbine. A reheater (e.g. another combustion chamber) may be used to add heat to the flow between the two turbines. The additional heat energy may be derived from a renewable energy source such as solar energy.

As shown in FIG. 1, exhaust gases output from the CTG facility 102 may be fed to an HRSG facility for extracting heat from the exhaust gas flow to facilitate generating steam to operate a steam-to-electricity turbine. The HRSG facility 104 may include a metal duct that may be enclosed by carbon steel casing for directing the CTG's hot exhaust gas past a series of metal tubes (that carry the feedwater) to an exhaust stack. Inside the metal tubes, circulating feedwater is heated to produce steam in steam drums (not shown in FIG. 1). The HRSG facility 104 may be of horizontal type in which the CTG exhaust gases flow horizontally through the metal duct. Alternatively the HRSG facility 104 may be of a vertical type in which the CTG exhaust gases flow vertically.

The HRSG facility 104 may be a single pressure HRSG facility that may have only one steam drum and may generate steam at a single pressure level. The HRSG facility 104 may alternatively be a multi-pressure HRSG facility that may employ two (double pressure) or three (triple pressure) steam drums. A triple pressure HRSG facility 104 may consist of three sections: a Low Pressure (LP) section, an Intermediate Pressure (IP) section, and a High Pressure (HP) section. One or more steam drums may be provided in each pressure section of the HRSG facility 104 to storing feedwater and generating steam at each pressure. The drums may include one or more internal mechanisms to separate the feedwater from the steam and to provide storage for large volumes of feedwater. The feedwater level in each drum may be maintained by level control valves. Further, each drum may be provided with internal distributors, baffles, shields, separators and internal piping. The separators may facilitate maintaining good steam quality by preventing carry-over of feedwater into internal piping sections that contain steam. The drums may also have provisions for chemical feed, sampling, and blowdown.

In embodiments, heat transfer surfaces of the HRSG facility 104 may consist of vertical banks of tubes. The tubes may be bare, or may have fins applied to provide extended surface for increased heat transfer. The material of the tubes may vary in order to be compatible with the pressure and temperature of steam and with the temperature of the exhaust gases that comes in contact with these tubes. The temperature of the gases may be highest at the HRSG facility inlet and may decrease through successive sections of the HRSG facility 104 as heat is transferred to the feedwater. Subsequently, the temperature of the gases may be reduced. Finally, these gases may exit from the HRSG facility 104.

As noted above an HRSG facility 104 may include more than one pressure level section. Each such section may include, in addition to other components: an economizer facility 138, an evaporator facility 140 and one or more superheater facility sections 142. The economizer facility 138 may be the first component in the feedwater flow path so that feedwater temperatures have not yet reached saturation and therefore it contains no steam. The economizer facility 138 may be an array of tubes that expose the feedwater to a preheater before it is fed to the evaporator facility 140 and ultimately to the superheater facility 142. Multiple preheater sections may be employed in an economizer to enhance the function of the economizer. Further, the economizer facility 138 may receive high pressure feedwater supplied by a boiler feed pump 144. In one embodiment, the pressurized, preheated feedwater from the economizer facility 138 may then be fed to the evaporator facility 140. Alternatively the economizer facility 138 may supply preheated feedwater from the HRSG 104 to a solar boiler feed pump (not shown) of the SHES facility 114 (see the note below the HRSG facility 104 in FIG. 1). Other configurations of the economizer facility 138 and other feedwater paths into and out of the economizer facility 138 are possible and therefore included herein.

The HRSG facility 104 may include multiple evaporators for generating steam. Each evaporator facility 140 (also known as a high pressure boiler) may consist of a steam drum, downcomers, feeder tubes, modules, and riser tubes disposed to create a natural circulation effect of the feedwater and generated steam. The natural circulation may ensure that the feedwater is continuously moving within the HRSG facility 104 tubes to remove and replace the steam produced due to the difference in density between the feedwater and steam. As the CTG facility's exhaust gas heats the evaporator tubes, a steam/water mixture may be formed in the tubes that may be less dense than the feedwater in the downcomers; thus, the mixture rises up to the steam drum and ultimately may be sent to the superheater as saturated vapor. The CTG exhaust gas, after heating the evaporator tubes may discharge in the atmosphere through the exhaust stack at the low temperature end of the HRSG facility 104. The heating of the feedwater in the evaporator facility 140 may include using high pressure boilers to heat the feedwater. In embodiments, the evaporator may utilize a forced circulation system for the feedwater. The forced circulation system may use a pump to maintain circulation of feedwater in the tubes of the evaporator facility 140. The evaporator may be configured with a variety of tube designs including parallel tubes, plates, circular coils, and the like.

The process of generating steam from inlet feedwater in the HRSG 104 may continue with the saturated steam from the evaporator facility 140 being passed to a superheater facility. The superheater facility 142 may include one or more superheaters connected in series, depicted in FIG. 1 as superheater 1 and superheater 2. A superheater facility 142 is used to increase steam generation provide from the evaporator facility 140 and to control the final steam ‘superheat’ temperature so that it facilitates efficient operation of the steam turbine generator. A superheater may be configured with flow tubes disposed in a variety of configurations including horizontal, vertical, and the like. The superheater tube configuration may be based on an accompanying evaporator configuration in an HRSG 104; in particular the superheater may be based on the type of high pressure boiler employed in the evaporator. A horizontal superheater tube configuration may generally be used for a D-Frame Evaporator facility if the exhaust gases flow is vertical at the outlet. A vertical superheater facility tube configuration may be used with an ‘A’-frame or an ‘0’-frame evaporator facility and with the ‘D’-frame evaporator facility if the exhaust gases exit horizontally. An ‘I’ frame super heater configuration may include both horizontal and vertical tubes and may be used with an I-Frame Evaporator facility.

In a hybrid power plant 100 configuration that includes an SHES 114, the superheater facility 142 of an HRSG 104 may receive high pressure steam from the SHES facility 114 in addition to receiving steam from an HRSG 104 evaporator facility 140. In embodiments, a high pressure, high temperature steam from the SHES facility 114 may be applied before the final superheater facility 142 (depicted in FIG. 1 as superheater 2).

Further the HRSG facility 104 may include a boiler blowdown facility 148 for collecting dissolved solids and particulates in the steam that are present in the feedwater and concentrated in the boiler as the steam evaporates and leaves them behind. The blowdown facility 148 may further send collected solids to a waste facility (not shown here). The blowdown facility 148 may also send some of the steam that is captured/produced in the blowdown process to the condenser facility 170 to be converted back to feedwater for reuse. Although a range of boiler blowdown facility 148 configurations are possible, one exemplary configuration includes a continuous cascading system from the evaporator boiler to a high pressure steam drum, to an intermediate steam drum, and from the intermediate pressure steam drum to a continuous blowdown tank.

Although the HRSG in FIG. 1 is depicted as comprising functions based on several separate components, other embodiments of an HRSG are possible including embodiments with more or fewer components, embodiments that integrate the functions of the HRSG in a single vessel, and the like.

The high pressure, high temperature steam from the HRSG facility 104 may be utilized at the STG facility 108 to extract thermal energy from steam, and convert it into rotary motion. Exemplary embodiments and operation of a steam turbine generator 108 are now described.

The STG facility 108 may include a steam turbine 150, a reduction gear 152 and a generator 154. The steam at the steam turbine 150 may be passed through a nozzle to emit a high velocity jet of steam. This jet of steam may impinge on shaft-mounted vanes or blades in the turbine 150, causing the jet of steam to undergo a change of direction of motion giving rise to a change in momentum and therefore a force to turn the shaft. In embodiments of the invention, a steam turbine may be an ‘axial flow’ type or a ‘radial flow’ type turbine.

In another embodiment of a steam turbine generator 108, the steam turbine 150 may be an impulse turbine that affects a drop in steam pressure in nozzles rather than in as a result of moving the blades. This may be obtained by making the blade passage a constant cross-sectional area. In an impulse-reaction turbine, the drop in pressure may take place in the nozzles as well as in causing the blades to move. The pressure drop suffered by steam while passing by the moving blades may cause a further generation of kinetic energy that causes the blades to react and add to the propelling force that is applied to the turbine shaft. The residual stream left after transferring the heat energy to the turbine may be sent to a condenser facility for recycling into feedwater.

The output of the steam turbine 150 may be applied to a generator 154, such as through a reduction gear 152 or directly without a reduction gear 152 for larger size STG 150. The reduction gear 152 may allow the generator 154 to operate at a lower rotational speed than the steam turbine shaft by lowering the speed of the steam turbine shaft that is applied to the generator 154. The generator 154 may convert the mechanical energy of the steam turbine's rotating shaft into electrical energy by applying the (reduced speed) rotary shaft to a stator that interfaces with an armature via a magnetic field as is known in the art.

Further referring to FIG. 1, a hybrid power plant 100 may take advantage of solar energy to generate and/or enhance steam by way of a parabolic trough solar array facility 112 and SHES facility 114 for accumulating and utilizing the solar energy. A parabolic trough solar array 112 may use long, parabolic-shaped minors to collect and focus sunlight onto a receiver tube that contains a Heat Transfer Fluid (HTF) which may be used in the SHES 114 to produce steam. The parabolic mirrors may be coated with a highly reflective material, such as silver, polished aluminum, and the like. Further, the minors may be a single piece constructed in a parabolic shape or may be made up of two or more mirrors placed at angles to one another to form a near-parabolic shape. These mirror shapes and finishes are only exemplary; other minor shapes and finishes are possible and are included herein.

In an example of a parabolic trough solar array 112, the array may include a plurality of reflectors (e.g. parabolic minors) that may be positioned over an arc shaped support in such a way that the focal line is coincident with the central line of one or more conduits passing over it. A reflector may be placed on the arc shaped support that enables the reflection of the solar energy directly on the one or more conduits. The reflector may be parabolic and the focal line of the parabolic reflector may be coincident with one or more conduits in the longitudinal direction.

Further, the HTF may flow in the conduit being exposed to the reflected sunlight to absorb the concentrated solar energy to convert low temperature HTF that enters the field into high temperature HTF exiting the field. Low temperature HTF from the SHES facility 114 may be introduced into an HTF return port on the conduit in the trough array. The concentrated sunlight may heat the HTF to a high temperature while it moves through conduit in the trough array. This high temperature HTF may be utilized in the SHES facility 114 to convert feedwater to steam. The HTF is preferably a substance that remains stable and does not change phase at high temperatures under low pressures because substances with a relatively low boiling point at low pressures may change to steam resulting in a bi-phase HTF which generally poses significant challenges that are not present when a stable HTF is used. Although water may be used as an HTF, generally it must be highly pressurized to avoid boiling which introduces disadvantages to the HTF conduit system because at least some of the joints of the HTF conduit typically are movable joints which may be difficult to maintain at high pressure; therefore a substance such as oil is often uses as an HTF.

The one or more HTF carrying conduits may be constructed using different material such as steel, alloy steel, copper, brass, aluminum and the like. The conduits may be of different shapes including triangular, circular, elliptical, square and the like. Further, the conduits may be oriented vertically, horizontally or tilted at an angle to maximize collection of the solar energy.

The high temperature HTF may be passed from the solar field to the SHES 114. The exemplary SHES facility 114 in FIG. 1 may include a solar boiler feed pump 158, a solar economizer facility 160, a solar evaporator or boiler facility 162, a solar superheater facility 164, and the like. The SHES facility 114 may receive feedwater and/or steam from the HRSG economizer facility 138 at an input to the solar boiler feed pump 158.

The solar boiler feed pump 158 may be operated continuously or intermittently. However, stopping the feedwater flow that is associated with intermittent boiler feed pump 158 operation will likely result in undesirable steaming in economizers; therefore boiler feed pumps are almost always continuously operated. A more serious consequence of cutting off the feedwater flow in a fired boiler is potential loss of water level in the boiler leading to a boiler explosion. The temperature of the HTF and controls associated with the solar economizer facility 160 may determine the type of operation of the solar boiler feed pump 158. In addition, the capacity of the solar boiler may be a factor in determining boiler operation. Based on the capacity of the solar boiler, a float type switch may be provided to control the operation of the solar boiler feed pump 158 to facilitate intermittent operation of the pump. In another example, a modulating feedwater regulator may be provided to control the flow of feedwater in the solar economizer facility 160 depending upon the level of feedwater in it. This may facilitate continuous operation of the solar boiler feed pump 158. The solar boiler feed pump 158 may be designed in accordance with the capacity of the solar economizer facility 160, the solar boiler facility 162, the solar superheater facility 164, the feedwater level in solar economizer facility 160, the solar boiler facility 162, the evaporation rate of the solar economizer and/or solar boiler and other parameters as known in the art.

The type of operation such as continuous operation or intermittent operation of the solar boiler feed pump 158 may determine the type of pump to be used. For example, a turbine driven centrifugal pump may be used for continuous operation, while a motor driven centrifugal pump may be used for an intermittent operation.

The solar boiler feed pump 158 may be designed for particular temperatures and feedwater pressures. For example, the solar boiler feed pump 158 may be designed to operate at 230 degrees Fahrenheit and/or pressures above 5 psi.

Water received by the HRSG facility 104 from the condensate pump may be fed into the solar economizer facility 160 through the solar boiler feed pump 158. In addition, the HTF may flow through the solar super heater 164, then through the solar boiler 162, and finally through the solar economizer facility 160 before being circulated back in the parabolic trough solar array 112 by an HTF circulation pump 168. The solar economizer facility 160 may reduce the overall energy required by the solar boiler by heating the feedwater before it enters the solar boiler facility 162 by using the residual heat in the HTF prior to being reintroduced to the solar field. In addition, the solar economizer facility 160 may increase the efficiency of the hybrid power plant 100 by using the waste heat from the solar boiler's hot exhaust to preheat the feedwater being introduced to the solar boiler. A bypass may be provided to flow a portion of the HTF flow around the solar economizer 160 to prevent steaming in the economizer by maintaining the temperature of the feedwater leaving the economizer below the saturation temperature.

In one example of SHES 114 operation, the high temperature HTF may be provided to the solar super heater 164 through a hot HTF header interface to the SHES 114. The solar superheater facility 164 may absorb the heat of the HTF and transfer it to the working fluid (e.g. feedwater output from the solar boiler) to generate superheated steam. Subsequently, the temperature of the HTF exiting the superheater may fall. At this stage, the HTF may flow to the solar boiler facility 162. The solar boiler facility 162 may absorb some of the heat from the HTF to produce steam. This may result in further cooling of the HTF as it moves to the solar economizer facility 160 and the available heat in the HTF is used to raise the temperature of the feedwater received from the solar boiler feed pump 158. The HTF may then be pumped into the cold HTF port as shown in FIG. 1.

The solar economizer facility 160 may be comprised of a plurality of horizontal tubular elements that may be bare tubes with extended surface features. The bare tubes may be of various sizes and may be arranged in hairpin or multi-loop arrangements. In addition, the heating surface of the tubes may be constructed using a low-carbon steel, thereby reducing the effect of corrosion. The solar economizer facility 160 may alternatively be configures as a waste heat boiler that may be designed to absorb heat from radiant or convective heat sources. For example, one or more waste heat boilers may be coupled with the solar boiler facility 162 and/or the solar super heater facility 164 to absorb the heat radiated thereby. The waste heat boilers may then be utilized in heating the feedwater entering the solar boiler facility 162 which may increase the overall heat utilization within the SHES facility 114.

The solar economizer 160 may be coupled to the solar boiler 162. Waste heat from the solar boiler 162 may be utilized by the solar economizer 160 for increasing the temperature of the feedwater in the solar economizer 160. Additionally, the portion of the HTF that remains above a particular temperature may be provided (e.g. pumped) to the solar boiler facility 162 for transfer to the feedwater. The HTF that falls below a predetermined temperature may be fed to the HTF circulation pump 168 that may propel the HTF back to the parabolic trough solar array 112 for heating.

The solar boiler facility 162 may include safety values, feedwater level indicators, bottom blow down valve, a continuous blow down valve, a flash tank, automatic blowdown/continuous heat recovery facility, steam drum internals, low feedwater cutoff, surface blowdown line, feedwater check valve, top feed, desuperheater tubes or bundles, chemical injection line and other components as known in the art.

In various environments, such as in dry, high heat environments, the reclamation and reuse of water in a hybrid power plant 100 may be a valuable feature that may increase efficiency and decrease the need for additional water or fluid supply. After water has been used in the power plant for operations such as human consumption, maintenance, and the like, it may be fed to a water supply system (WSS 118) where it is processed and reclaimed. Once processed, it may be reused in the plant, thus decreasing the need for a fresh supply of water.

Water and it's converted state of steam within the hybrid power plant 100 is often called a working fluid and is generally at or near its lowest temperature after it has been processed (e.g. air cooled or water cooled) through a condenser 170 on the steam outlet of the STG 108. The working fluid changes phase from water to steam to drive the STG 108 and is condensed back to water before re-entering the steam generation process. Replenishment water may be introduced in association with the condenser 170 operation that turns the used steam back into water. Therefore, a source of replenishment may be operationally connected to the condenser 170 functional block. Even though replenishment water may be available, it may be limited by the environment, such as the hot, dry, desert-like environment in which a hybrid power plant 100 may find plentiful sunlight. Therefore, cooling of the STG 108 output steam to return the working fluid to water may be done using a ‘dry condenser’ approach that attempts to reuse as much of the steam as practical rather than releasing the steam to the environment.

With little-to-no ambient moisture available for conversion to water, another source of water molecules may be needed to produce water for replenishment, maintenance, and human consumption/use. A water supply system 118 may provide water by extracting it from the combustion exhaust flow generated by the CTG 102 functional block. Although the ambient air that is inlet to the CTG 102 has little moisture, the Hydrogen in the combustible fuel (e.g. a fossil-based fuel) combines with oxygen during the combustion process, producing moisture that can be extracted by cooling the exhaust flow to condense a portion of the exhausted moisture. The condensed exhaust flow water may then be treated (e.g. chemical binding of the CO2 to produce sodium bicarbonate, or other process), filtered, processed through a demineralization process, and stored. The stored water can be retrieved for various purposes. It can be further processed to produce potable water, such as by adding essential salts. The stored water can be used to replenish the STG working fluid. In addition, the water can be used for washing solar field minors, CTG compressor washing, equipment maintenance or other purposes. Therefore, in an aspect of the invention, water may be supplied for use in association with an integrated solar combined cycle power plant through water recovery from a gas combustion exhaust flow of a CTG 102 and a HRSG 104.

A water supply system (WSS) 118 may also receive water from a condensate pump or may include a condensate pump 172 that receives water from a steam-water condenser 170 as described herein. The WSS 118 may include a chiller, such as an air cooled chiller 174 to further cool the condensate provided by the condensate pump 172. The WSS 118 may also include an innovative water reclaim exchanger 178 for collecting water from the exhaust flow through condensation. The exhaust flow water reclaim exchanger 178 may operate by providing cooled condensate through a conduit that may be disposed so that the exhaust flow passes over the conduit carrying the cooled condensate to promote condensation of water in the exhaust flow on the exterior of the conduit. This condensation may be collected and fed to a water treatment system 180. The working fluid of the hybrid power plant 100 may be directed to pass through the condensate cooler 182 and the water reclaim exchanger 178 so that these two elements comprise an integral part of the working fluid flow path in a hybrid power plant 100.

An exemplary embodiment of a water reclaim exchanger 178 is now described. The water reclaim exchanger 178 may include an exhaust inlet port, a water exchange passageway, and an outlet port. The exhaust inlet port may be connected to a source of CTG exhaust flow, such as an exhaust outlet port of an HRSG 104 to facilitate flow of the CTG exhaust flow into the water exchange passageway. The water exchange passageway may be disposed between the exhaust inlet port and the outlet port so that exhaust flow entering the exhaust inlet port flows through the water exchange passageway and exits through the outlet port to an exhaust stack or other functional block of the hybrid power plant 100.

The water reclaim exchanger 178 may be configured with bare or finned conduit disposed within the water exchange passageway so that the exhaust flow flowing through the passageway makes condensable contact with the finned conduit. While finned conduit may be used, bare conduit is also a good choice because it may allow for better coating with corrosion resistant material and may allow for better drainage of condensate. When the surface temperature of the finned conduit is below the dew point of the exhaust flow (e.g. when the cooled condensate working fluid flows through the finned conduit), a portion of the moisture in the exhaust flow will condense on the finned conduit. As the moisture condenses, it will accumulate and flow to a collection point from which it can be routed to a water treatment system 180. The finned conduit may be constructed of a material, or a combination of materials, that are resistant to contamination or corrosion due to the contaminants in the exhaust flow. In an embodiment, the finned conduit may be coated with TEFLON fluoropolymer.

Working fluid that may be supplied by a condenser associated with the STG 108 may be cooled further by the condensate cooler 182 before being supplied to the finned conduit. The finned conduit may connect the condensate cooler 182 in the WSS 118 to an HRSG boiler feed pump 144 while passing the working fluid through the water exchange passageway.

The finned conduit may be disposed in the water exchange passageway so that the working fluid inlet is nearest the exhaust outlet, where the exhaust gas is coolest by virtue of having traveled through the passageway, and the working fluid outlet is nearest the exhaust inlet where the exhaust gas is hottest. As the cooled working fluid passes through the conduit in the passageway, it absorbs heat from the exhaust gas flow. Even though the temperature of the working fluid increases with distance traveled through the passageway, the temperature of the exhaust gas flow exposed to the finned conduit carrying the working fluid is higher than the working fluid. This results in a cooling of the exhaust gas flow as the working fluid passes through the conduit in the passageway and absorbs heat from the exhaust gas flow.

In order to improve re-usability and reclamation of water, the hybrid power plant 100 may be fitted with an exhaust flow scrubber 190 disposed at the WSS exhaust inlet port to facilitate removal of a portion of the corrosive contaminants from the exhaust flow prior to entering the water exchange passageway. The exhaust flow scrubber 190 may be a chemical and/or mechanical facility that reduces the concentration of some elements (e.g. toxic, corrosive, etc) in the exhaust flow thereby: (i) improving the water exchange efficiency; (ii) reducing the amount of treatment of the extracted water that is required; (iii) potentially increasing the life of the exchange passageway and finned conduit; and (iv) improving the quality of the portion of the exhaust flow that is sent into the environment. Chemical scrubbing may include the application of amine that may facilitate capturing CO2. The captured CO2 may be used for carbon capture and storage (CCS), carbon sequestration, or other applications requiring pure CO2. Another use of amine in the scrubber may be to remove hydrogen sulfide from the exhaust flow.

While not all of the water vapor that is present in the exhaust flow may be condensed for extraction in the water exchange passageway, it may be estimated that approximately twenty percent of the available water is extracted from the exhaust flow. It is anticipated herein that with higher efficiency water exchange passageway operation, much more than twenty percent of the available water may be extracted from the exhaust flow.

Water extracted from the exhaust flow in the water exchange passageway may be routed to a water treatment system 180. Because this water will contain impurities that were present in the exhaust flow, such as CO2, it may be treated to remove or neutralize the impurities. CO2 may be present in the water because a portion of CO2 dissolves in the water when condensed and is removed from the exhaust flow. By removing this dissolved portion of the CO2 from the exhaust flow, the WSS 118 also improves the quality the hybrid power plant 100 environmental exhaust. In this way, removing water from the exhaust flow not only provides water for replenishment, maintenance, and human use, it also benefits the environment by reducing the carbon footprint of the hybrid power plant 100.

Water that is extracted from the exhaust flow may be treated in a variety of ways including chemical processing, filtering, and the like.

Water treatment may yield a clean water flow for storage of approximately thirty to thirty-five percent of the water introduced into the treatment facility 180. The remaining portion may be used for flushing contaminants and the like in the treatment process. In embodiments, water treatment may yield clean water flow for storage of greater or lesser amounts than thirty percent of the water introduced into the treatment facility. Any remaining portion not required for or not suitable for use as working fluid may be used for various other suitable purposes.

The treated water may be stored for later use, such as in a storage tank 184. The stored water may be used to replenish the hybrid power plant working fluid. Depending on the type and amount of treatment done to the stored water, it may be ready for introduction to the working fluid. However, additional treatment may be performed as needed to prepare the stored water for use in the hybrid power plant 100. In an example, the stored water may be processed through a demineralization facility prior to being used as working fluid in the hybrid power plant 100. The demineralized water may be forwarded to the condenser 170 with a make-up pump 188 that provides sufficient water pressure. The water may be routed from the storage tank 184 through the make-up pump 188 to an entry port of the condenser 170 at the output of the STG 108 where it may be mixed with the condenser output and fed into the condensate cooler 182 of the WSS 118. In this way, feedwater can be reintroduced into the system.

The stored water may be provided to a maintenance or industrial water supply system associated with the hybrid power plant 100 to facilitate use of the water for a variety of maintenance and/or industrial purposes.

In addition to being used as working fluid replenishment and maintenance or industrial use, the stored water may be further treated (e.g. by introducing essential salts) to become potable water.

Water vapor concentration in the exhaust flow may be increased through the use of pure oxygen or rich oxygen for combustion in the CTG 102 and/or HRSG 104. This may increase the partial pressure of water vapor and increase the dew point in the exhaust flow gas.

Direct contact condensation may also be applied in the passageway to cool the exhaust flow thereby increasing heat transfer efficiency and potentially avoiding corrosion associated with the water reclaim exchanger 178.

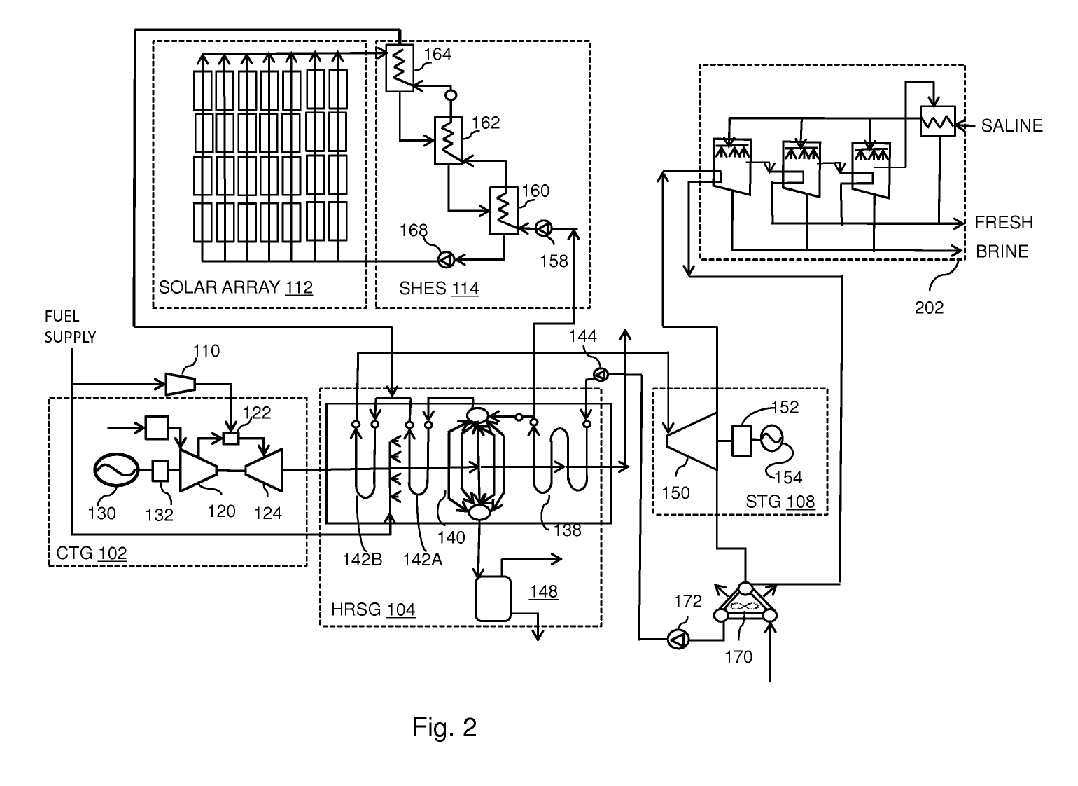

Referring to FIG. 2, a hybrid power plant generally as described in FIG. 1 is depicted without the water supply system and further including a desalination facility 202. The desalination facility 202 may receive steam from the hybrid power plant and use the steam to boil salt or brackish water to separate the water from the brine and collect the water. The steam may be provided from the steam turbine generator facility in the form of low pressure steam. The low pressure steam may be extracted from the steam turbine generator before or after it has been used to generate electricity.

The desalination facility 202 may pass the steam through a series of fresh water heaters that heat the saline water sufficiently to cause the brine to precipitate out, leaving behind fresh water. The steam may be passed through the series of heaters to extract substantially all of the heat from the steam. Alternatively, the steam may be applied to a first desalination stage that heats the saline water and passed the steam back to a condenser facility of the hybrid power plant. The heated saline water passes from the first desalination stage to a second desalination stage where fresh water is produced. This sequence may be repeated any number of times until the water produced from a desalination stage is no longer hot enough to facilitate further desalination.

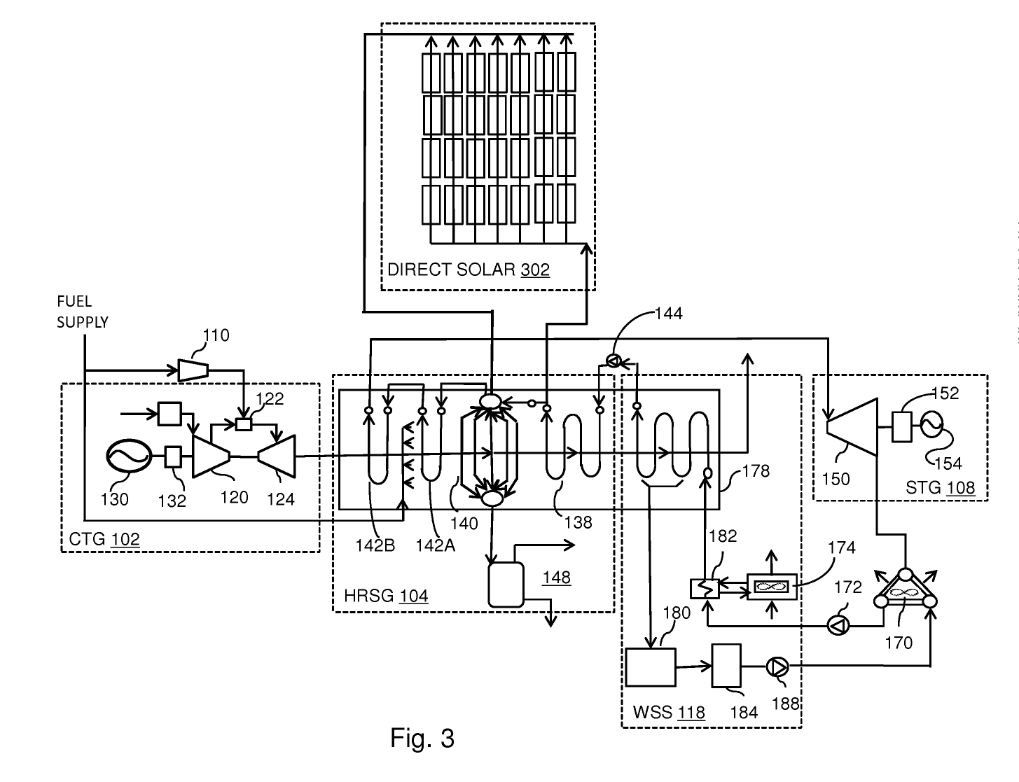

Efficiency of the system may be increased in additional ways that involve the feedwater. For example, solar energy may play an increased role in heating feedwater, such as through the use of a direct solar feedwater heating facility 302 which may eliminate the need for using an intermediate heat transfer fluid (HTF). FIG. 3 depicts such an embodiment of the hybrid power plant in which the HTF fed parabolic solar array and SHES facility are replaced by a direct solar feedwater heating facility 302. The description of the CTG facility, the HRSG facility, the STG facility, the WSS facility, and the steam condenser facility is similar to that described with reference to FIG. 1. In the embodiment of FIG. 3, the direct solar feedwater heating facility 302 is provided with receiver conduits that receive a portion of the feedwater from the HRSG economizer facility to transfer heat to the feedwater thereby reducing the combustion fuel consumption of the HRSG that is required to heat the feedwater to produce superheated steam. The direct solar feedwater heating facility 302 may raise the temperature of the feedwater close to its saturation temperature. Upon exiting the direct solar feedwater heating facility the saturated feedwater may be reintroduced to the evaporator facility of the HRSG facility.

In embodiments, the direct solar feedwater heating facility 302 may be implemented as a parabolic trough solar array. The parabolic trough solar array may use long, parabolic-shaped minors to collect and focus sunlight onto receiver conduits that contain the feedwater. The parabolic minors of the parabolic trough solar array may be coated with a highly reflective material, such as silver, polished aluminum, and the like. The mirrors used for the parabolic trough may be a single piece constructed parabolic shape. Alternatively parabolic troughs may be made up of two or more mirrors placed at angles to one another to form a near-parabolic shape. Other shapes and finishes of the mirrors are possible and are included herein.

The parabolic trough solar array may alternatively be configured to include a plurality of reflectors that may be positioned over an arc shaped support in such a way that the focal line is coincident with the central line of one or more conduits passing over it. A reflector may be placed on the arc shaped support that enables the reflection of the solar energy directly on the one or more conduits. The reflector may be parabolic and the focal line of the parabolic reflector may be coincident with one or more conduits in the longitudinal direction.

The receiver conduits may be constructed using different materials such as steel, alloy steel, copper, brass, aluminum and the like. The conduits may be of different shapes including triangular, circular, elliptical, square and the like. Further, the receiver conduits may be oriented vertically, horizontally or tilted at an angle to maximize collection of solar energy.

As depicted in FIG. 3, direct solar heating of working fluid via a concentrating solar field 302 may be combined with a water supply system 118 to produce water in the hybrid power plant. As described above in FIG. 1, a water supply system may reclaim water by extracting moisture from a gas turbine exhaust flow that passes through the HRSG 104 and the WSS 118. When direct solar feedwater heating is combined with water reclamation, improved efficiency of the overall system may be improved. In addition, because the solar super heat field 302 may be a reflective trough type field, water demand may be increased to maintain high quality reflective surfaces so water reclamation can be used to meet that increased demand.

In embodiments, a hybrid power plant may also be configured in such a manner that solar energy is used to directly heat steam. By utilizing solar energy to create supplemental superheated steam, the necessity for combustion fuel in the hybrid power plant will be decreased thereby yielding a more fuel efficient system.

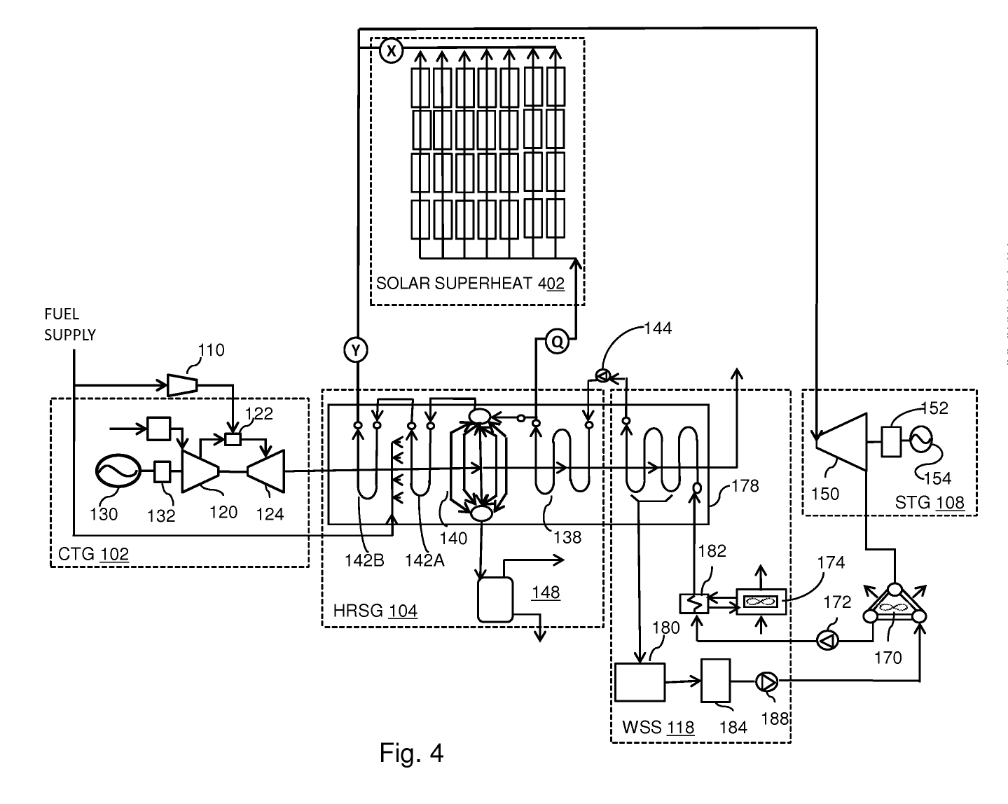

FIG. 4 depicts an alternate embodiment of the hybrid power plant in which a direct solar steam superheater 402 is deployed in place of the parabolic array and SHES that uses HTF depicted in FIG. 1. The description of the CTG facility, the HRSG facility, the STG facility, the WSS facility, and the steam condenser facility is similar to that described with reference to FIG. 1. The direct solar steam superheater facility 402 may facilitate heating of steam that is already present in the system. In embodiments, the direct solar steam superheater facility 402 may be a parabolic trough solar array that may include a plurality of conduits; these conduits may absorb heat when exposed to solar radiation. The absorbed heat may be utilized to increase the temperature of the steam passing through the conduit. A detailed description of exemplary parabolic trough solar array elements is described herein and elsewhere so it will not be repeated here.

As shown in FIG. 4, the direct solar steam superheater facility 402 may be coupled to the HRSG evaporator. The steam at the evaporator may be distributed between the direct solar steam superheater facility and to a gas fired superheater as describe herein with the purpose of utilizing solar energy to superheat a portion of the steam, thereby reducing the amount of combustion fuel required in the HSRG. Steam that enters the direct solar steam superheater facility may be circulated through one or more conduits. During circulation, the solar radiation may be absorbed by the steam resulting in superheated steam. The HSRG superheated steam may be combined with the direct solar steam superheater steam (e.g. at the discharge outlet of the direct solar steam superheater facility). The combined superheated steam may then be used to run the steam turbine or any other suitable purpose in the system.

By using the direct solar steam superheater facility 402 to directly heat the steam in order to generate superheated steam, the need for Heat Transfer Fluid (HTF) may be eliminated. In addition, the losses incurred because of HTF may also be minimized. Further, by eliminating the need for HTF, the temperature of steam will be independent of a decomposition temperature of the HTF.

Although not depicted in FIG. 4, the superheated steam generated in the direct solar steam superheater facility 402 may alternatively be routed to the HSRG superheater to improve the efficiency and/or superheating capacity of the HSRG superheater.

As depicted in FIG. 4, superheating steam via a concentrating solar field 402 may be combined with a water supply system 118 to produce water in the hybrid power plant. As described above in FIG. 1, a water supply system may reclaim water by extracting moisture from a gas turbine exhaust flow that passes through the HRSG 104 and the WSS 118. When direct solar superheating of steam is combined with water reclamation, improved efficiency of the overall system may be improved. In addition, because the solar super heat field 402 may be a reflective trough type field, water demand may be increased to maintain high quality reflective surfaces so water reclamation can be used to meet that increased demand.

In accordance with an embodiment of the present invention, a portion of the steam generated via the boiler facility of HRSG may be further superheated for driving a steam turbine. However, this may require further consumption of fossil fuels by the boiler facility. Therefore, to increase the power generation efficiency, this portion of the steam may be directed into a second concentrating solar power (CSP) field in the solar-fossil-fuel hybrid power plant to produce superheated steam. The second CSP field may be trough, tower, or Fresnel dish type as has been described above in detail. The superheated steam from the CSP field may be thereon combined with steam produced by the HRSG and directed to a steam generator to drive a steam turbine. In accordance with this embodiment, the fossil fuel consumption may be reduced with the introduction of the second CSP for superheating.

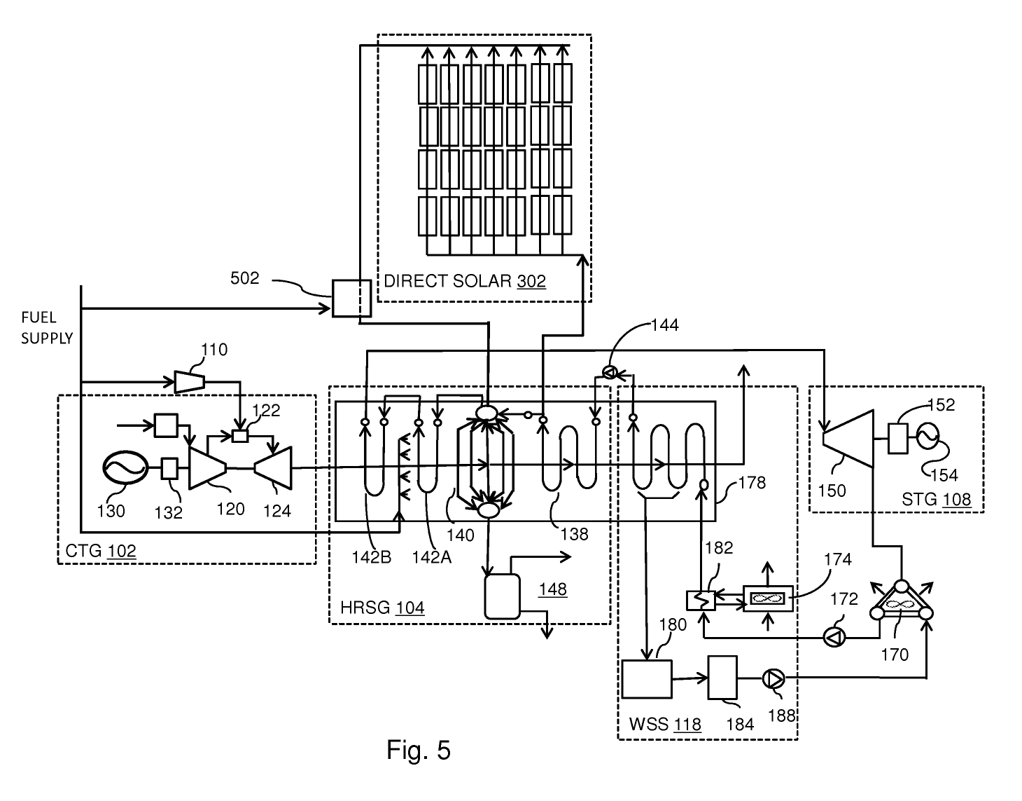

Referring to FIG. 5 that depicts a variation of the hybrid power plant of FIG. 3 with supplemental heating capacity to accommodate variations in solar feedwater heating. In the embodiment of FIG. 5, the HRSG may be configured with additional fossil fuel burners that may operate conditionally and/or as needed. A hybrid solar-fossil fuel power plant that includes a direct solar feedwater heating facility 302 may be configured with an HRSG that includes fossil-fuel heaters that are designed to provide supplemental heat to the feedwater when the direct solar feedwater heating facility 302 cannot heat the feedwater within a predetermined limit of saturation temperature due to insufficient solar energy (e.g. excessive or prolonged shadowing of the parabolic mirrors). Sensors, such as feedwater temperature, solar energy sensors, and the like may provide an indication to a control system of insufficient heating of the feedwater by the direct solar feedwater heating subsystem. In response to the indication, the control system may activate one or more supplemental fossil-fuel fired heaters in the HRSG to raise the temperature of the feedwater. Additional heat may be applied to the feedwater in the HRSG by igniting additional burners, routing feedwater to a supplemental boiler facility, and the like. The heaters may be disposed in-line with a connection between the output of the direct-solar feedwater heating facility and the HRSG. Alternatively, the heater(s) may be configured within the HRSG and may be used to provide supplemental heat to the direct-solar feedwater heating facility 302 and/or to provide supplemental heat to feedwater that bypasses the direct-solar feedwater heating facility 302 within the HRSG.

As depicted in FIG. 5, providing supplemental heat 502 to an HRSG may be combined with a water supply system 118 to produce water in the hybrid power plant. As described above in FIG. 1, a water supply system may reclaim water by extracting moisture from a gas turbine exhaust flow that passes through the HRSG 104 and the WSS 118. The exhaust flow from the supplemental heater may be directed to a water reclamation chamber for water extraction. The supplemental heat exhaust flow may be combined with the gas turbine exhaust flow and water may be reclaimed from the combined flow. Alternatively, a separate chamber for extracting water from the supplemental heat exhaust flow maybe used.

As described herein, hybrid power systems are highly complex and variable in any number of factors can lead to inefficiencies, and as a result, aspects of the present invention relate to control systems for the hybrid power systems. As indicated herein, and just for clarification, not all hybrid power systems have been described or fully described; however, the embodiments that relate to controlling of hybrid power systems both specifically relate to the embodiments described herein and to hybrid systems that are not described herein.

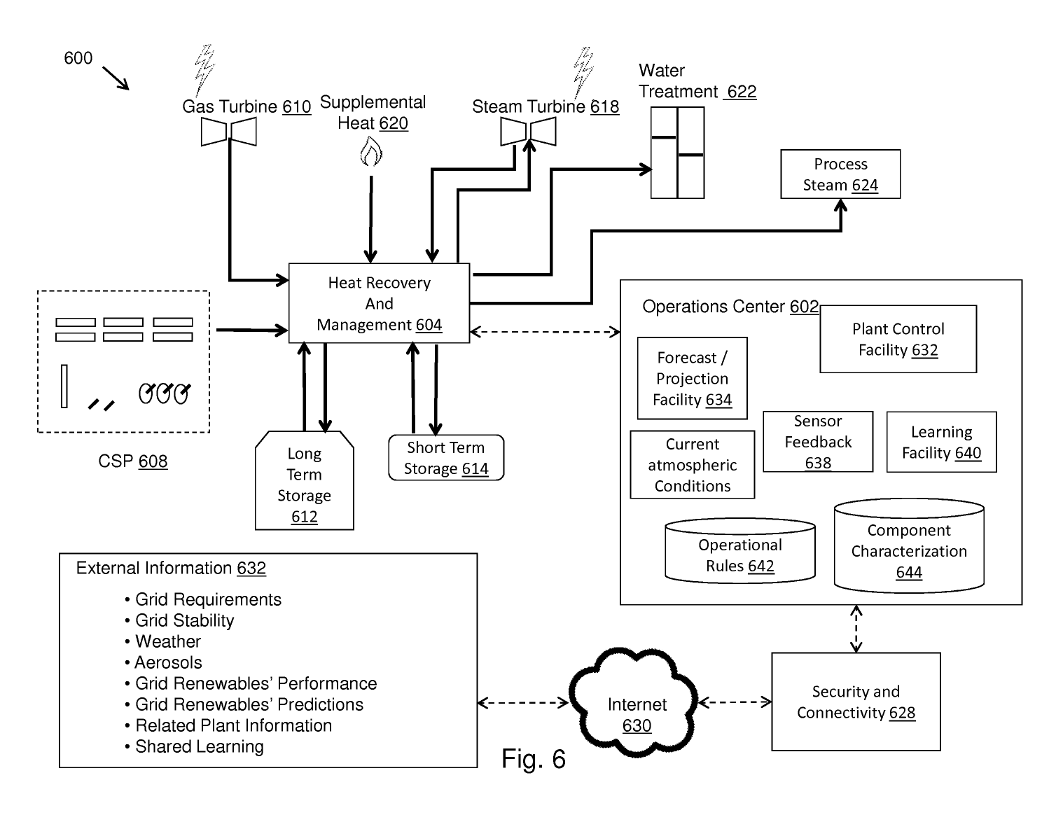

FIG. 6 illustrates an embodiment of a hybrid power system with an operations center 602. As can be seen in FIG. 6, the hybrid power system 600 consumes and produces a number of things. Each of the heavy weight lines going to and from the heat recovery and management facility are meant to depict thermal flows of fluids and/or vapors. Generally speaking, one can see that the heat recovery and management system 604 receives thermal inputs from a number of sources and then provides thermal output to a number of loads. Of course, as has been noted, this is just one hybrid power system configuration and it is not necessary that a hybrid system include all of the illustrated inputs, outputs, resources or other items. Again referring to FIG. 6, one can see that the heat recover and management facility 604 is fed thermally processed fluid and or vapor from a concentrating solar field (CSP) 608, waste heat from a gas turbine 610, long term thermal storage facility 612, short term thermal storage facility 614, waste heat from a steam turbine 618, and supplemental heat 620 from a primary source of heat (e.g. gas heat, coal heat, biofuel heat, etc.). The heat recovery and management facility 604 then manages the delivery of thermal energy to at least one load, such as a steam turbine 618, water treatment facility 622, process steam 624 (e.g. for use by a secondary system or load), etc. For simplicity sake, FIG. 6 does not illustrate all of the components in the hybrid power system. For example, as illustrated herein, the CSP field 608 may circulate a fluid or vapor through a system and the system may transfer heat through heat exchangers. In other embodiments the CSP field 608 may feed steam directly into a portion of the hybrid power system 600 without the use of heat exchangers.

The hybrid power system of FIG. 6 generates electrical power through the gas turbine 610 and the steam turbine 618. The waste heat from each of these turbines may then be recovered by the heat recovery and management facility 604. Traditionally, a combined cycle plant recovers waste heat from the gas turbine 610 for use by the steam turbine 618; however, there are situations where it is desirable to also capture the waste heat from the steam turbine 618. The hybrid power system 600 may also be configured to power a water treatment facility 622 (e.g. desalination, water cleaning, etc.).

The CSP field 608 illustrated in FIG. 6 includes an illustration of a trough configuration, tower configuration, and dish configuration. It should be understood that the CSP field 608 is not limited to this configuration or to these technologies; this illustration is meant to capture the idea that thermal energy from a concentrated solar energy field is fed into the heat recovery and management facility 604.

The hybrid power system 600 illustrated in FIG. 6 also includes an operations center 602, security and connectivity facility 628, connection to the Internet (or some other form of network) 630, and external information sources 632. In this embodiment, the operations center 602 controls the thermal flows and other parameters of the hybrid power system 600. The operations center 602 may draw on internal and external resources to optimize the control of the hybrid power system 600. The operations center may have internal resources such as a plant control facility 632, forecast and projection facility 634, sensor feedback facility 638, learning facility 640, operational rules database 642, component characterization database 644, etc. The operations center 602 may gain access to external information by connecting to the Internet through the security and connectivity facility 628. The external information 632 includes grid requirements, grid stability, weather, aerosols, grid renewables' performance, grid renewables' predictions, related plant information, shared learning, and other information.

Now that the general configuration illustrated in FIG. 6 is complete, we turn to some more detailed embodiments relating to the operations center 602. The operations center 602 includes a plant control facility 632. The plant control facility 632 controls the hybrid power system 600. It controls the flows of thermal energy in the heat recovery and management system 604. It controls the power levels consumed and/or produced by the turbines. It also controls the thermal flows to any of the several loads (e.g. steam turbine, water treatment, and process steam, and the like). The plant control facility 632 does all of this based on knowledge of demand, sensor feedback, weather predictions, the hybrid power systems performance characteristics, knowledge gained through the learning system 640 about the hybrid power plants performance and its components performance, hybrid power plant system component characteristics, operations rules, etc. The plant control facility 632 may also control the hybrid power system 600 based on the external information.

Many of the components in the hybrid power system 600 have energy performance characteristics. Some of the components have characteristics relating to thermal inertia. The component characterization database 644 includes data relating to the hybrid power systems components. For example, the hybrid power system 600 may have a boiler and the boiler may take 30 minutes to achieve thermal stability or optimal performance. This characterization of the boiler may be stored in the component characterization database 644. As another example, the CSP field 608 may react in a particular way given certain variables, such as weather or aerosol conditions or predictions. These and other characterizations of the CSP field 608 may be stored in the component characterization database 644. The component characterization database 644 may store performance characterization information with the long term storage facility 612, short term storage facility 614, CSP field 608 (or sub-components), boilers, heat exchangers, supplemental heaters, gas turbines 610, steam turbines 618, water treatment facility 622, process steam facility 624, other related systems or subsystems.

Components in a concentrating solar power-enabled power plant may be characterized in a variety of ways that may relate to operation of the plant, maintenance, performance limits, warranty factors, productivity ratings, green house gas contributions, and the like. One area of characterization includes thermal inertia. Thermal inertia characterization data may be fairly stable for many components when operated well within their operating limits and lifetimes. However, efficient operation of a power plant may depend at least in part on understanding and applying the thermal inertia characterization of components in the operation of the power plant over a wide range of environmental conditions, adverse situations, peak demands, fuel quality variation, regulatory requirements, sources of solar power, and the like. A concentrating solar power plant may include a plurality of solar power concentrating technologies, including reflective trough fields, solar towers, Fresnel fields, and the like. Each of these solar power concentrating technologies and each implementation thereof may have important differences in thermal inertia to be factored into the operation of a solar-power-enabled power plant. In an example, it is generally understood that tower or Fresnel fields have less thermal inertia than a reflective trough solar concentrating field. By storing initial thermal intertia data for each type of solar concentrating technology that may be employed and monitoring the thermal contributions of each technology in a variety of environmental conditions and weather events, a learning system of a power plant may be able to adjust thermal inertia data; apply the thermal inertia data and the monitored data to establish a set of operational rules related to each of the solar power concentrating technologies; and adjust operational rules over time based on the thermal contribution of each technology under various real-world weather, environmental, and other conditions. An operations center may gather the thermal inertia data from a supplier of the solar power concentrating equipment (e.g. from design specification, production testing, field testing, field usage, and the like), combine that with data related to an installation process, pre-use qualification process, periodic audits, and the like to produce various thermal inertia measurements, and operational criteria for use thereof. The operations center may combine that data with weather prediction data to identify certain control operations and/or sequences of operational actions that are to be applied (manually and/or automatically) ahead of and/or during a predicted weather condition to ensure that each solar power concentrating source contributes near optimum thermal energy for production of steam.

The operational rules database 642 and the component characterization database 644 may include models of the pertinent elements, controls, systems, subsystems, and interactions thereof for the hybrid power plant 600. The models may be processed under various weather conditions, operating conditions, adverse conditions, energy demand, operational fault conditions, simulated concentrating solar field thermal contributions, ambient temperature, and a wide variety of factors to predict how the power plant may perform. The model data may be combined with data captured from the operation of the power plant to further enhance the operation of the power plant and/or to further validate or improve the predictability of power plant performance through modeling of the actual monitored data. The models themselves may be adaptable based on monitored data, external data, and the like.

Models may exist for a variety of predicted weather conditions and those models may be consulted for determining potential adjustments to operational rules based on a predicted weather condition.

The hybrid power plant 600 may be operated by the plant control facility 632 in accordance with operational rules, which may be stored in the operational rules database 642. The operational rules may cover how to respond in certain situations. For example, the grid may be demanding as much electrical power as possible from the hybrid power system 600 and the rules may cover how to ramp the system up to its max electrical energy output in a minimum amount of time. Similarly, weather forecasts may predict certain conditions and the operational rules may cover how to control the hybrid power system 600 in response to such conditions. Further, hybrid power system sensors may be indicating certain operational conditions and the operational rules may cover how to control the hybrid power system 600 in response to the sensor feedback. The operational rules may be influenced by operational and/or individual power plant operational models. Alternatively, the operational rules may be provided as inputs to various models in an attempt to validate the operational rules, the model, the performance of the power plant, and the like.

The learning facility 640 is a system that learns the behaviors of the hybrid power system 600 and then modifies the component characterizations in the component characterizations database 644 and/or the operational rules in the operational rules database 642, in accordance with the newly learned behavior. The learning system 640 may, for example, interpret sensor feedback data from the hybrid power system 600 in relation to the current atmospheric conditions, past conditions and/or predicted conditions to learn how the hybrid power system 600 or any of its subcomponents react to these conditions. Once the learning system 640 understands how a component, group of components, or the hybrid power system reacts and acts based on presented conditions, the learning system may then modify the information contained in the operational rules database 642 or component characterizations database 644. The plant control facility 632 will then be able to consult the new and/or modified operational rules when controlling the hybrid power plant 600. In embodiments, the learning system 640 may be consulted by the plant control facility 632 as, before, or after the plant control facility 632 controls the hybrid power plant 600.

The learning facility 640 may also or instead gain system and component performance understanding through the use of the external information. For example, while the learning system 640 is monitoring the hybrid power plant performance (e.g. through sensor information 638) the learning system 640 may be analyzing external information 632. The learning system 640 may learn how the hybrid power plant 600 operates by understanding how other power plants operate (e.g. through the related plant information). The related plant information may include power plant performance information that generally relates to the performance of other power plants (e.g. other hybrid power plants, CSP plants, fossil fuel power plants, etc.). The related plant information may also include other plant performance information based on real time, quasi-real time, recent past, or past information as an indication of how atmospheric conditions have impacted the other plants. This information may provide insight about how the weather is going to affect the hybrid power plant 600. If it is predicted that a weather condition or system that is moving over another power plant is now moving toward the present hybrid power plant 600, the learning system 640 may retrieve external data relating to the other power plant performance to prepare the present hybrid power plant 600 to respond in the best way. The learning system 640 may develop or modify operational rules and/or provide guidance and/or instructions to the plant control facility 632.

The learning facility may learn from the monitoring of the power plant, but it may also learn from the results of processing models using simulated or actual power plant performance data Likewise, the learning system may facilitate providing actual power plant learned data to one or more models or modeling systems accessible by the operations center 602 in real-time or otherwise to facilitate modeling of the operation and performance of the power plant. The learning facility may determine that certain operating aspects of the power plant are inconsistent with a given model (e.g. a model of a particular aspect or an interaction with a particular aspect). The learning facility may therefore influence modeling of the power plant components, interactions, performance, operation, and the like. In an embodiment, models may be modified based on learning facility learnings. In situations where a model may not exist, the learning facility may provide data about an component, operation, interaction, and the like of the power plant that may be used by a modeling system to produce a model.

In embodiments an adverse atmospheric event may be predicted to occur at the power plant in the future. Depending on the type and severity of the adverse event, different performance rules may be extracted from the operational rules database. Each of the rules in the operational rules database may be informed or influenced by the component characteristic information in the component database. So, for example, a short term adverse event (e.g. short term cloud coverage) may cause one rule to be extracted and followed whereas a more severe adverse atmospheric event (e.g. a storm, many clouds, persistent dust, etc.) may cause a different rule to be extracted and followed.

Long term storage of heat produces in a hybrid fossil-fuel-solar concentrating power plant may require a substantial supply of heat. This supply of heat may come from any of a concentrating solar power field, waste heat from fossil fuel combustion processes (e.g. gas turbine combustion), supplemental heat provided to a heat recovery and steam generator or heat recovery and management facility, waste heat from steam generation, and the like. To ensure that long term storage is maintained at a level that is sufficient to provide heat for a predetermined duration of time in lieu of availability of other sources of heat (e.g. heat from a solar power concentrating field), sufficient heat must be provided to the long term storage on an ongoing basis. Relying solely on a concentrating solar power heat source (e.g. a solar field) may be costly due to the larger size field that may be needed to provide heat for both steam turbine operation and long term storage maintenance. Therefore, the fossil-fuel-solar concentrating power plants described herein may utilize other sources of heat to establish and maintain long term storage.

Heat from a solar power concentrating field may be used to supply or maintain long term heat storage. A gas-fired turbine produces waste heat that may be used by a heat recovery steam generator to produce steam. A portion of this waste heat may also be used to provide heat to a long term storage system. Likewise, supplemental gas/coal heat may be used to maintain long term storage. This supplemental heat may be provided directly for maintaining the long term storage or itself may be waste heat from a supplemental heating process that provides heat to a heat recovery steam generator to augment a thermal contribution from a concentrating solar field. Other sources of heat that may be collected and applied to maintaining long term storage may include waste heat from various steam generation facilities (e.g. a heat recovery steam generator, a steam boiler, a steam superheater, a steam-to-water condenser, heat transfer fluid cooling, and the like). While each of these heat sources may contribute to maintaining long term storage, the sources may be combined to supply the long term storage.

An operations center as described in respect to FIG. 6 may maintain operational rules and/or thermal inertia data for these various sources of heat and may control the transfer of heat from these sources to the long term storage to facilitate efficient use of the sources of heat for producing steam and for long term storage. By applying various operational rules, the operations center may control the power plant and combine the various sources of heat under a wide range of operational, environmental, adverse, and other conditions. In particular, weather prediction data may be useful in determining a time in the near future when long term storage may be needed to supply heat because the thermal contributions of the solar power concentrating fields will be compromised (e.g. due to extended cloud cover). In such a situation, operation rules may be activated that may direct more of the waste heat from the various sources noted above to build up the long term storage capacity.

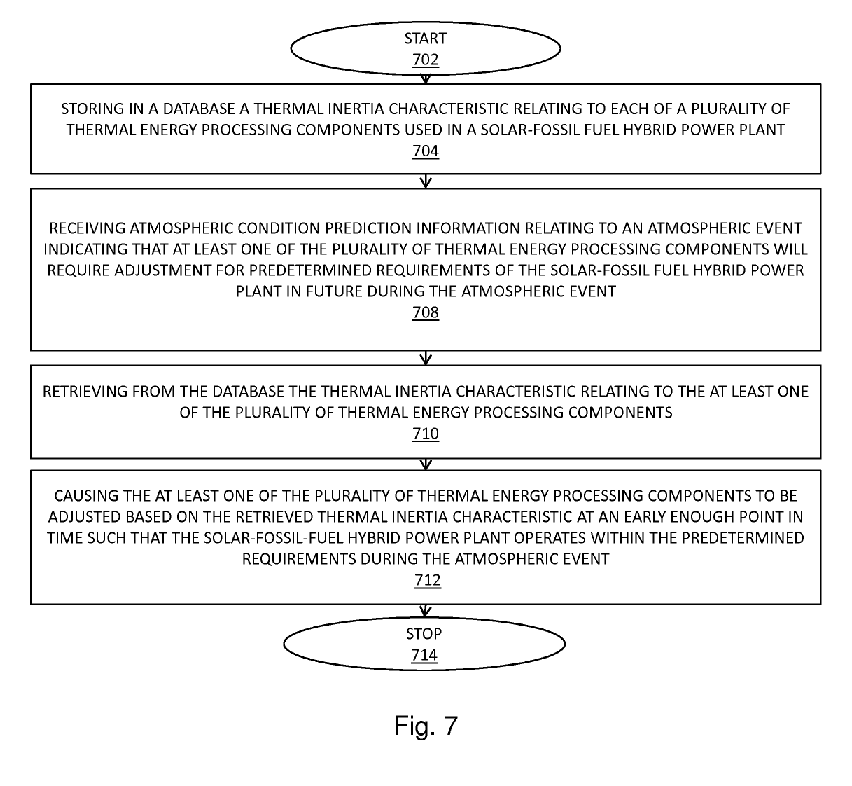

Referring to FIG. 7, a flow chart for control of a hybrid power plant in response to predicted atmospheric conditions using component characterization information is depicted. The process of control begins at step 702. At step 704, a thermal inertia characteristic relating to each of a plurality of thermal energy processing components used in the solar-fossil-fuel hybrid power plant may be stored in a database referred to as the component characterization database. The thermal inertia characteristic may include such as data relating to thermal stability and optimal performance of a boiler used in the hybrid power plant, behavior of CSP field toward certain variables and the like. In such case, boiler characteristic information and CSP field data may be stored in the component characterization data.

At step 708, atmospheric condition prediction information relating to an atmospheric event may be received at the operations center. The atmospheric event may be capable of drawing an impact on certain performance parameters of the hybrid power plant and may act as a variable to define its optimal performance. Accordingly, the atmospheric condition information for the atmospheric event may indicate that at least one of the plurality of thermal energy processing components may require adjustment.

At step 710, the thermal inertia characteristic relating to the at least one of the plurality of the thermal energy processing components may be retrieved from the component characterization database. At step 712, an adjustment may be made in the at least one of the plurality of thermal energy processing components based on the thermal inertia characteristic retrieved at step 710. The adjustment may be made at an early enough point in time such that the solar-fossil-fuel hybrid power plant may operate within the predetermined requirements during the atmospheric event. The at least one of the plurality of thermal energy processing components in which the adjustment is made may be referred to as the adjusted components or adjusted thermal energy processing components. The adjusted thermal energy processing components may now be capable of performing in an effective and optimal manner in light of the impacts generated by the atmospheric event on the hybrid power plant. The process of control of the hybrid power plant in response to the predicted atmospheric conditions due to the atmospheric event may end at step 714.

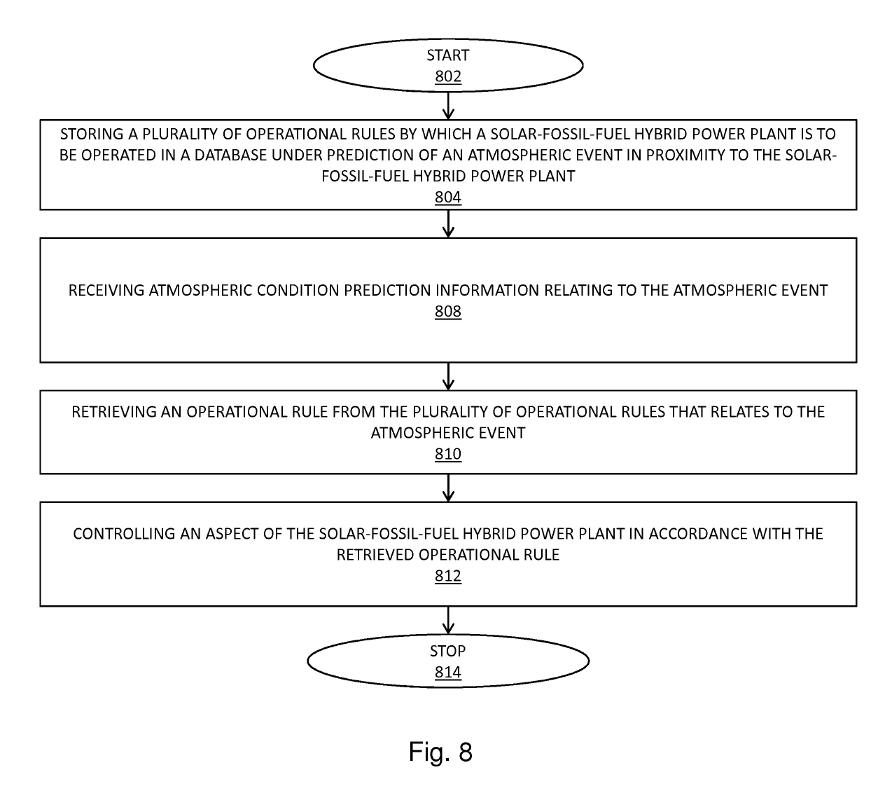

Referring to FIG. 8, a flow chart for control of a hybrid power plant using operational rules based on predicted atmospheric conditions is depicted. The process of control of the hybrid power plant using operational rules begins at step 802. At step 804, a plurality of operational rules by which the solar-fossil-fuel hybrid power plant is to be operated may be stored in a database referred to as operational rules database (depicted in FIG. 6). The operations rules and the operational rules database have been described in conjunction with FIG. 6 in detail.

At step 808, atmospheric conditions associated with the predicted atmospheric event in proximity of the hybrid plant may be received at the operations center. At step 810, an operational rule from the plurality of operational rules that may relate to the atmospheric event may be retrieved. The operational rule may refer to those rules that may be required to be adjusted/modified/changed/redefined under prediction of the atmospheric event in proximity to the solar-fossil-fuel hybrid power plant. In accordance with various embodiments of the present invention, the atmospheric event may have a future impact on optimization, utilization and performance of various components of the solar-fossil-fuel hybrid power plant and accordingly, the adjusted/modified/changed/redefined operational rules may enable the solar-fossil-fuel hybrid power plant to be capable of sustaining the atmospheric conditions resulting from the predicted atmospheric event without any harm to the performance of the hybrid plant. At step 812, an aspect of the hybrid power plant may be controlled in accordance with the retrieved operational rule. The control process may end at step 814.

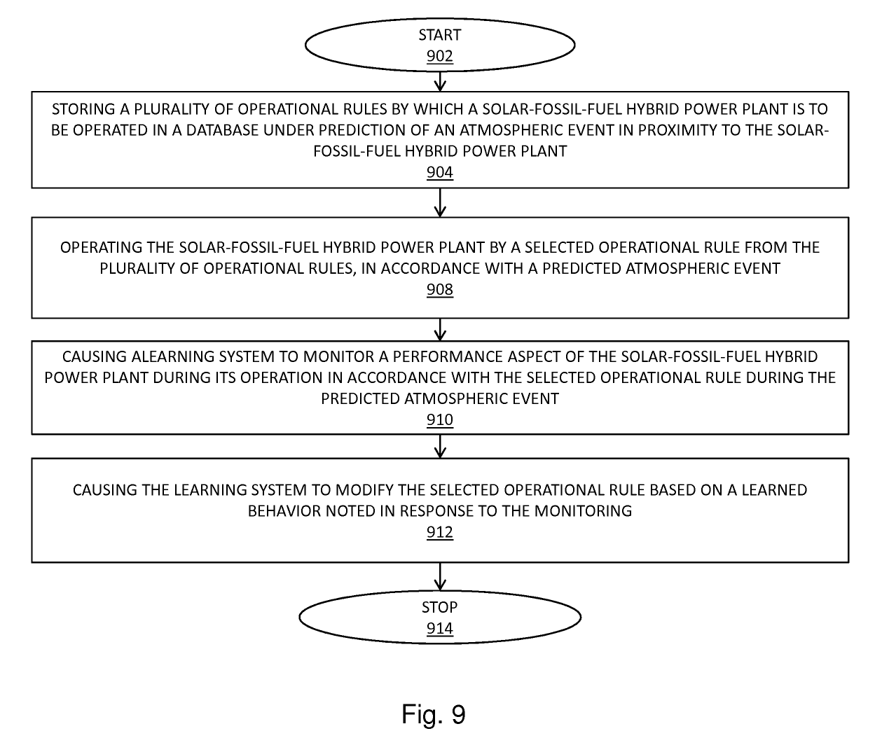

Referring to FIG. 9, a flow chart for control of a hybrid power plant using a learning facility is depicted. The control process may start at step 902. At step 904, a plurality of operational rules by which the solar-fossil-fuel hybrid power plant is to be operated may be stored in a database referred to as operational rules database (depicted in FIG. 6). The operations rules and the operational rules database have been described in conjunction with FIG. 6 in detail. At step 908, the solar-fossil-fuel hybrid power plant may operate based on a predefined operational rule that may be selected from the plurality of operational rules in accordance with an atmospheric event. The atmospheric event and the selection of the operational rule in accordance with the predicted atmospheric event have been described in conjunction with FIG. 8. At step 910, a learning facility such as the learning facility as described in conjunction with FIG. 6 may monitor a performance aspect of the hybrid power plant during its operation in accordance with the predefined selected operational rule during the predicted atmospheric event. At step 912, the learning facility may be caused to modify/change/redefine the selected operational rule based on a learned behavior in response to the monitoring as performed on step 910. The learning facility may learn the behavior of the hybrid power plant and accordingly modify the operational rule that may be stored in the operational rule database in accordance with the newly learned behavior. The hybrid plant may then be able to consult the new and modified operational rule during controlling of various components of the hybrid plant. A more detailed explanation of the learning facility has been made in conjunction with FIG. 6.

As described herein, concentrated solar power systems are highly complex and variable in any number of factors can lead to inefficiencies, and as a result, aspects of the present invention relate to control systems for the concentrated solar power systems. As indicated herein, and just for clarification, not all concentrated solar power systems have been described or fully described; however, the embodiments that relate to controlling of concentrated solar power systems both specifically relate to the embodiments described herein and to concentrated solar systems that are not described herein.

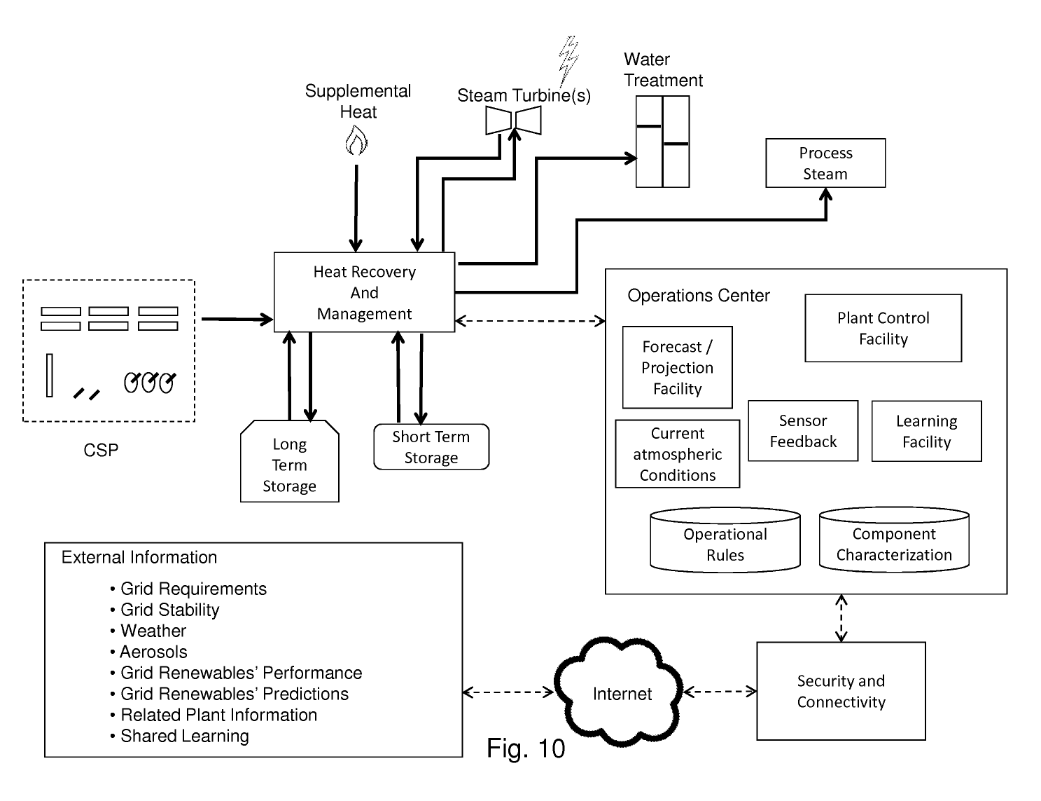

FIG. 10 illustrates an embodiment involving a concentrated solar power system with an operations center. As can be seen in FIG. 10, the concentrated solar power system consumes and produces a number of things. Each of the heavy weight lines going to and from the heat recovery and management facility are meant to depict thermal flows of fluids and/or vapors. Generally speaking, one can see that the heat recovery and management system receives thermal inputs from a number of sources and then provides thermal output to a number of loads. Of course, as has been noted, this is just one concentrated solar power system configuration and it is not necessary that a concentrated solar system include all of the illustrated inputs, outputs, resources or other items. Again referring to FIG. 10, one can see that the heat recover and management facility is fed thermally processed fluid and or vapor from a concentrating solar field (CSP), long term thermal storage facility, short term thermal storage facility, waste heat from a steam turbine, and optional supplemental heat from a primary source of heat (e.g. gas heat, coal heat, biofuel heat, etc.). The heat recovery and management facility then manages the delivery of thermal energy to at least one load, such as a steam turbine, water treatment facility, process steam (e.g. for use by a secondary system or load), etc. For simplicity sake, FIG. 10 does not illustrate all of the components in the concentrated solar power system. For example, as illustrated herein, the CSP field may circulate a fluid or vapor through a system and the system may transfer heat through heat exchangers. In other embodiments the CSP field may feed steam directly into a portion of the concentrated solar power system without the use of heat exchangers.

The concentrated solar power system of FIG. 10 generates electrical power through the steam turbine. The waste heat from the turbine may then be recovered by the heat recovery and management facility. The concentrated solar power system may also be configured to power a water treatment facility (e.g. desalination, water cleaning, etc.).

The CSP field illustrated in FIG. 10 includes an illustration of a trough configuration, tower configuration, and dish configuration. It should be understood that the CSP field is not limited to this configuration or to these technologies; this illustration is meant to capture the idea that thermal energy from a concentrated solar energy field is fed into the heat recovery and management facility.

The concentrated solar power system illustrated in FIG. 10 also includes an operations center, security and connectivity facility, connection to the Internet (or some other form of network), and external information sources. In this embodiment, the operations center controls the thermal flows and other parameters of the concentrated solar power system and other systems. The operations center may draw on internal and external resources to optimize the control of the concentrated solar power system. The operations center may have internal resources such as a plant control facility, forecast and projection facility, sensor feedback facility, learning facility, operational rules database, component characterization database, etc. The operations center may gain access to external information by connecting to the Internet through the security and connectivity facility. The external information includes grid requirements, grid stability, weather, aerosols, grid renewables' performance, grid renewables' predictions, related plant information, shared learning, and other information.

Now that the general configuration illustrated in FIG. 10 is complete, we turn to some more detailed embodiments relating to the operations center. The operations center includes a plant control facility. The plant control facility controls the concentrated solar power system as well as other systems (e.g. those systems depicted in FIG. 10). It controls the flows of thermal energy in the heat recovery and management system. It controls the power levels consumed and/or produced by the turbines. It also controls the thermal flows to any of the several loads (e.g. steam turbine, water treatment, and process steam). The plant control facility does all of this based on knowledge of demand, sensor feedback, weather predictions, the concentrated solar power systems performance characteristics, knowledge gained through the learning system about the concentrated solar power plants performance and its components performance, concentrated solar power plant system component characteristics, operations rules, etc. The plant control facility may also control the concentrated solar power system based on the external information.

Many of the components in the concentrated solar power system have energy performance characteristics. Some of the components have characteristics relating to thermal inertia. The component characterization database includes data relating to the concentrated solar power systems components. For example, the concentrated solar power system may have a boiler (in connection with the short term storage facility or long term storage facility, for example) and the boiler may take 30 minutes to achieve thermal stability or optimal performance. This characterization of the boiler may be stored in the component characterization database. As another example, the CSP field may react in a particular way given certain variables, such as weather or aerosol conditions or predictions. These and other characterizations of the CSP field may be stored in the component characterization database. The component characterization database may store performance characterization information with the long term storage facility, short term storage facility, CSP field (or sub-components), boilers, heat exchangers, supplemental heaters, steam turbines, water treatment facility, process steam facility, other related systems or subsystems.

The concentrated solar power plant may be operated by the plant control facility in accordance with operational rules, which may be stored in the operational rules database. The operational rules may cover how to respond in certain situations. For example, the grid may be demanding as much electrical power as possible from the concentrated solar power system and the rules may cover how to ramp the system up to its max electrical energy output in a minimum amount of time. Similarly, weather forecasts may predict certain conditions and the operational rules may cover how to control the concentrated solar power system in response to such conditions. Further, concentrated solar power system sensors may be indicating certain operational conditions and the operational rules may cover how to control the concentrated solar power system in response to the sensor feedback.

The learning facility is a system that learns the behaviors of the concentrated solar power system and then modifies the component characterizations in the component characterizations database and/or the operational rules in the operational rules database, in accordance with the newly learned behavior. The learning system may, for example, interpret sensor feedback data from the concentrated solar power system in relation to the current atmospheric conditions, past conditions and/or predicted conditions to learn how the concentrated solar power system or any of its subcomponents react to these conditions. Once the learning system understands how a component, group of components, or the concentrated solar power system reacts and acts based on presented conditions, the learning system may then modify the information contained in the operational rules database or component characterizations database. The plant control facility will then be able to consult the new and/or modified operational rules when controlling the concentrated solar power plant. In embodiments, the learning system may be consulted by the plant control facility as, before, or after the plant control facility controls the concentrated solar power plant.

The learning facility may also or instead gain system and component performance understanding through the use of the external information. For example, while the learning system is monitoring the concentrated solar power plant performance (e.g. through sensor information) the learning system may be analyzing external information. The learning system may learn how the concentrated solar power plant operates by understanding how other power plants operate (e.g. through the related plant information). The related plant information may include power plant performance information that generally relates to the performance of other power plants (e.g. other concentrated solar power plants, CSP plants, fossil fuel power plants, etc.). The related plant information may also include other plant performance information based on real time, quasi-real time, recent past, or past information as an indication of how atmospheric conditions have impacted the other plants. This information may provide insight about how the weather is going to affect the concentrated solar power plant. If it is predicted that a weather condition or system that is moving over another power plant is now moving toward the present concentrated solar power plant, the learning system may retrieve external data relating to the other power plant performance to prepare the present concentrated solar power plant to respond in the best way. The learning system may develop or modify operational rules and/or provide guidance and/or instructions to the plant control facility.

In an embodiment, the concentrated solar plant of FIG. 10 may be proactively controlled to optimally perform even during adverse atmospheric events such as clouds, high aerosols, dust in the air, high temperatures, low temperatures, etc. A forecast may indicate that an adverse atmospheric event is going to affect the concentrated solar plant. The operations center may take the predicted event information and react by extracting a performance rule from the operational rules database. The performance rule may take into account the thermal inertia characteristics associated with the components of the plant. As such, the plant control facility may understand how to react in advance of the event and during the event to maintain an optimal performance from the plant. For example, the adverse event may be predicted to be a short term event (e.g. passing clouds) and the thermal inertia characteristics of the CSP field stored in the database may indicate that the CSP field is only going to be slightly effected. So the performance rule that is extracted from the database may indicate that all systems should stay as is before and during the event. In another embodiment, the adverse event may be assessed as a longer term effect (e.g. more than just passing clouds, persistent dust, etc.) and the thermal characteristics of the CSP field may indicate that its output is going to be significantly effected. As a result, the performance rule associated with this more significant event may indicate that the short term storage facility should be prepared for use in advance of the event. Then the rule may indicate that the short term storage be used to contribute thermal energy to the heat recovery and management facility an appropriate point during the event that the input to the load (e.g. steam turbine, water treatment, process steam, etc.) is maintained within the required specifications, at least to the extent possible. The thermal energy from the short term storage may not be introduced to the heat recovery and management facility until the thermal energy from the CSP facility has deteriorated to a preset point and this may be regulated by the performance rule as well. In another embodiment, the adverse event may be even more serious (e.g. night fall, a storm, long term clouds or dust, etc.). In this event, the extracted performance rule may cause the short term storage to be prepared at an appropriate point in time in advance of the event and the long term storage may also be prepared in advance. Each additional thermal source may also come online at some point before, during, or following the event as prescribed by the performance rule. In another embodiment, supplemental heat may be used in a similar way as described above and herein. Certain performance rules in the operational database may contemplate more than one adverse event simultaneously occurring or occurring in near one another, either in time or space.

As described above, the learning system, in connection with one or more sensors (e.g. as described herein) as well as internal and external atmospheric condition observation systems, may learn the plant's behaviors during adverse events and the learning system may change rules or create new rules based on the learned behaviors.

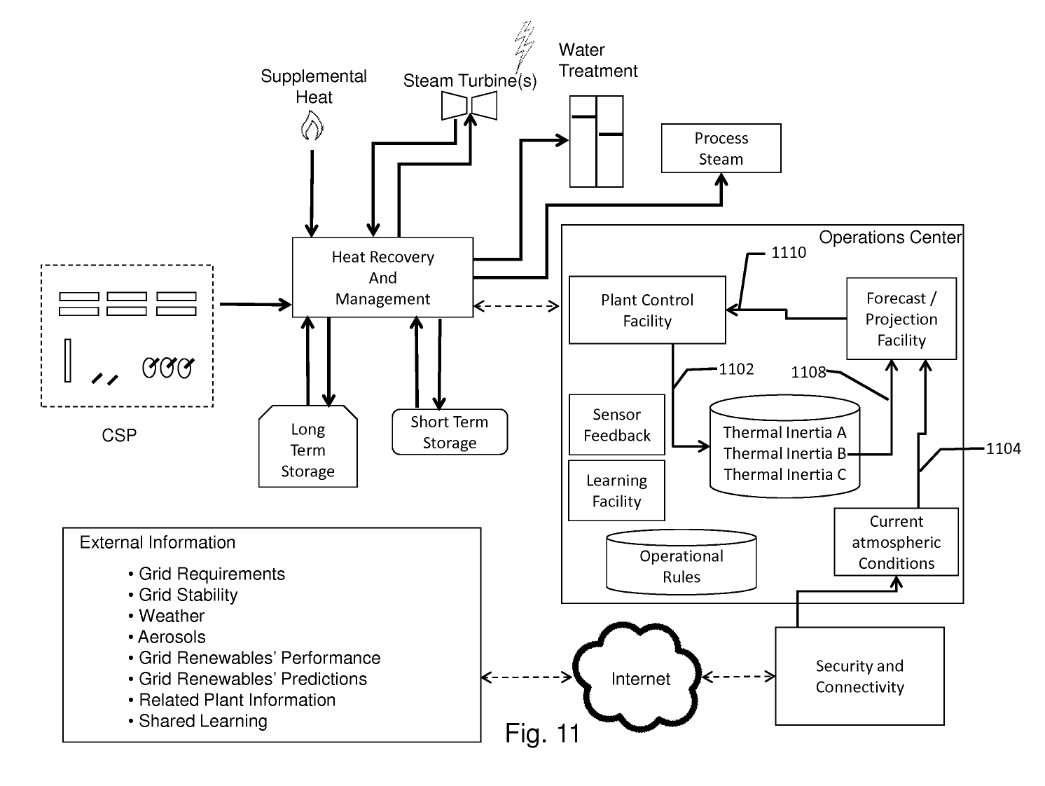

Referring to FIG. 11, which is an alternate embodiment of the power plant as described in FIG. 10, a process for controlling a concentrated solar power plant in response to predicted atmospheric conditions using component characterization information is presented. In particular this process relates to aspects of the operations center as follows. A thermal inertia characteristic relating to each of a plurality of thermal energy processing components used in the combined solar power plant are stored 1102 in a database that is accessible to components of the operations center. The operations center receives atmospheric condition prediction information 1104 relating to an atmospheric event indicating that at least one of the plurality of thermal energy processing components “the adjusted component” will require adjustment so that the combined solar power plant performs within pre-determined requirements in the future during the atmospheric. The thermal inertia characteristic relating to the adjusted component is retrieved 1108 to cause the adjusted component to be adjusted 1110 based on the retrieved thermal inertia characteristic at an early enough point in time that the combined solar power plant operates within a pre-determined requirements during the atmospheric event.

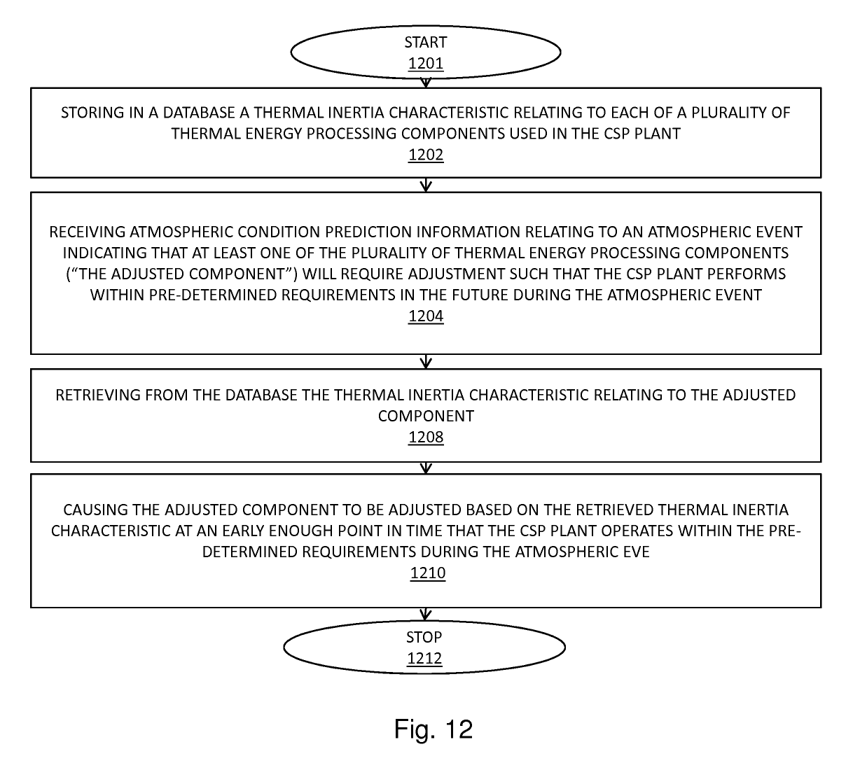

Referring to FIG. 12, which depicts a flow chart of an embodiment of the process depicted in FIG. 11, a method of controlling the concentrated solar power plant in response to predicted atmospheric conditions using component characterization information is presented. The method starts at step 1201 and proceeds to step 1102 in which a thermal inertia characteristic relating to each of a plurality of thermal energy processing components used in the combined solar power plant are stored in a database that is accessible to other components of the operations center. In step 1204 the operations center receives atmospheric condition prediction information relating to an atmospheric event indicating that at least one of the plurality of thermal energy processing components (“the adjusted component” will require adjustment so that the combined solar power plant performs within pre-determined requirements in the future during the atmospheric. The thermal inertia characteristic relating to the adjusted component is retrieved in step 1208 to cause the adjusted component to be adjusted in step 1210 based on the retrieved thermal inertia characteristic at an early enough point in time that the combined solar power plant operates within a pre-determined requirements during the atmospheric event. The process stops at step 1212.

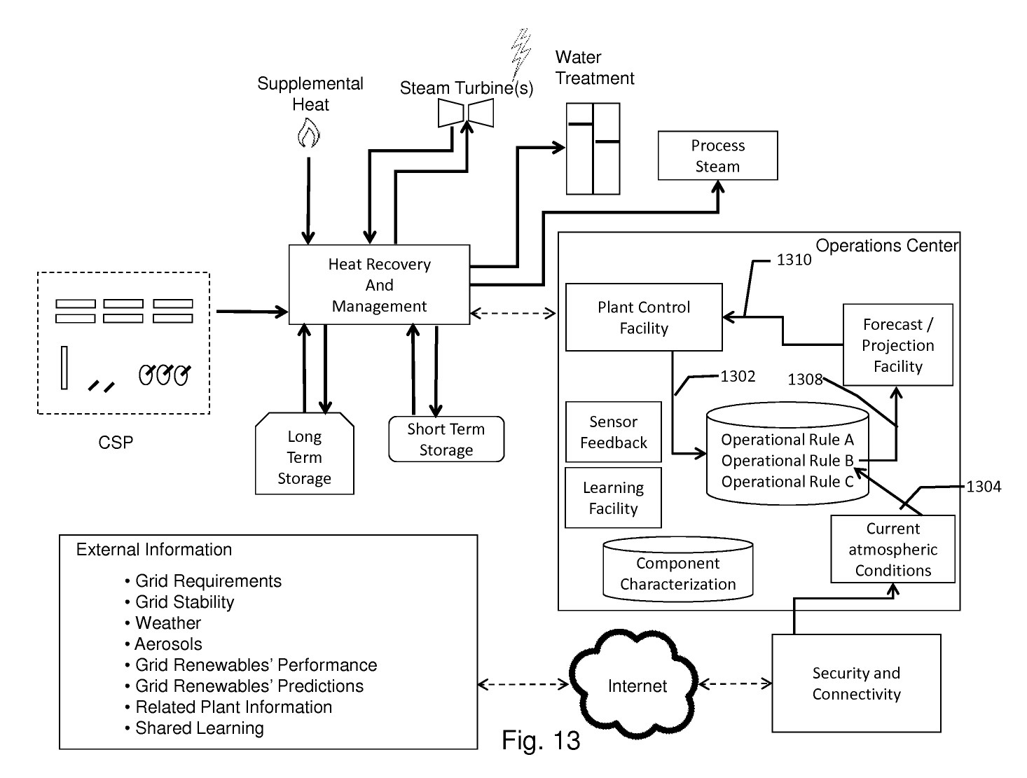

Referring to FIG. 13, which is an alternate embodiment of the power plant as described in FIG. 10, a process for controlling a concentrated solar power plant in response to predicted atmospheric conditions using operational rules is presented. In particular this process relates to aspects of the operations center as follows. A plurality of operational rules by which the combined solar plant is to be operated in a situation where certain atmospheric conditions are predicted to occur in proximity to the combined solar power plant are stored 1302 in a database that is accessible to components of the operations center. The operations center receives atmospheric condition prediction information 1304 relating to an atmospheric event. The operational rule that relates to the atmospheric event is retrieved 1308 to facilitate controlling 1310 an aspect of the combined solar power plant in accordance with the retrieved operational rule.

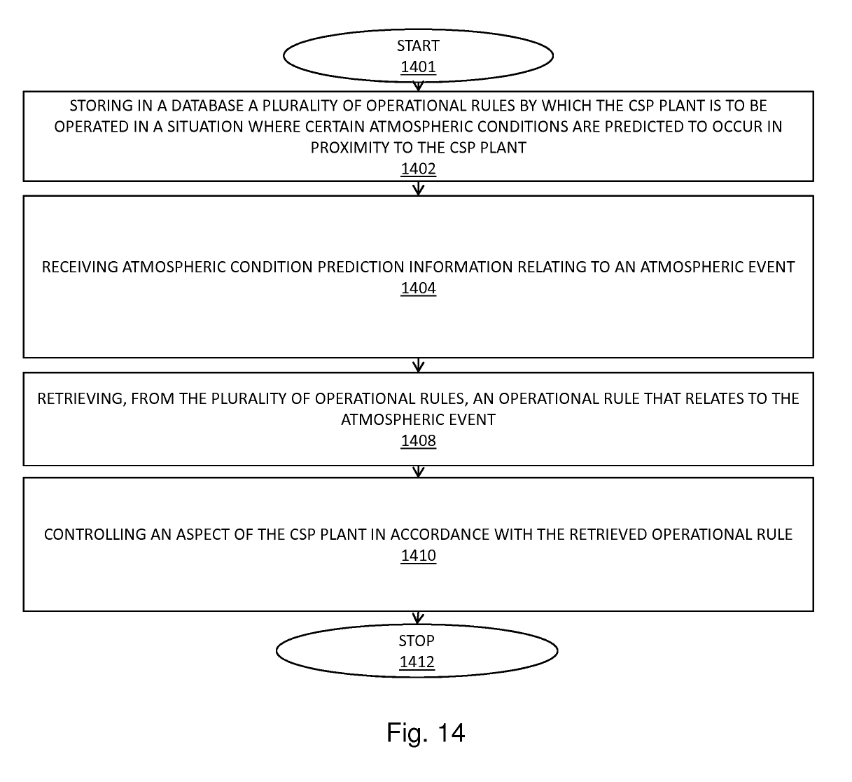

Referring to FIG. 14 which depicts a flow chart of an embodiment of the process depicted in FIG. 13, a method to facilitate controlling the concentrated solar power plant in response to predicted atmospheric conditions using operational rules is presented. The process starts at step 1401 and proceeds to step 1402 in which a plurality of operational rules by which the combined solar plant is to be operated in a situation where certain atmospheric conditions are predicted to occur in proximity to the combined solar power plant are stored in a database that is accessible to other components of the operations center. In step 1404 the operations center receives atmospheric condition prediction information relating to an atmospheric event. In step 1408, the operational rule that relates to the atmospheric event is retrieved. In step 1410 this facilitates controlling an aspect of the combined solar power plant in accordance with the retrieved operational rule. The process stops at step 1212.

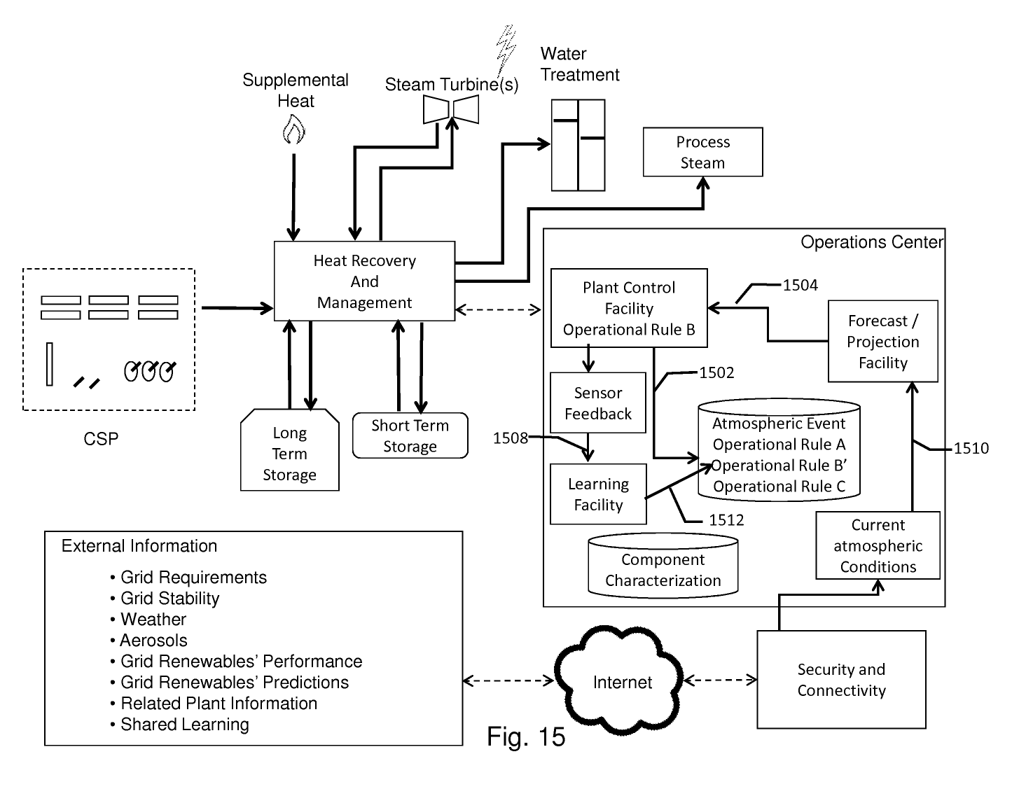

Referring to FIG. 15, which is an alternate embodiment of the power plant as described in FIG. 10 a process for controlling the concentrated solar power plant using a learning system is presented. In particular this process relates to aspects of the operations center as follows. A plurality of operational rules by which the combined solar plant is to be operated in a situation where certain atmospheric conditions are predicted to occur in proximity to the combined solar power plant are stored 1502 in a database that is accessible to components of the operations center. The operations center operates the concentrated solar power plant by a selected operation rule from the plurality of operational rules in accordance with a predicted atmospheric event 1504. This causes a learning system to monitor 1508 a performance aspect of the concentrated solar power plant during its operation in accordance with the selected operational rule during the predicted atmospheric event 1510. This further causes the learning system to modify 1512 the selected operational rule based on a learned behavior noted in response to the monitoring action.

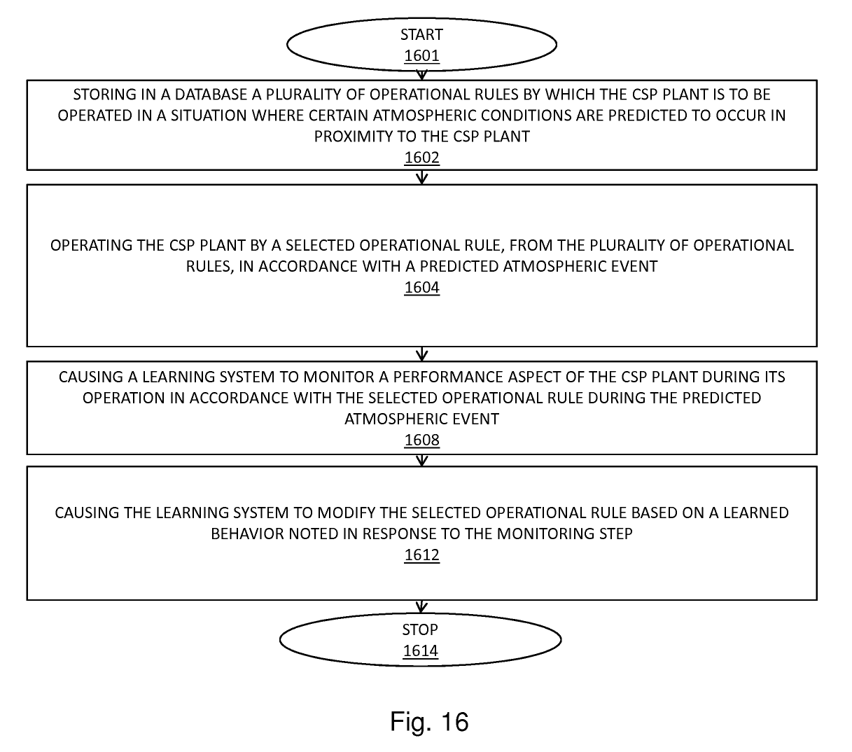

Referring to FIG. 16 which depicts a flow chart of an embodiment of the process depicted in FIG. 15, a method to facilitate controlling the concentrated solar power plant using a learning system is presented. The process starts at step 1601 and proceeds to step 1602 in which a plurality of operational rules by which the combined solar plant is to be operated in a situation where certain atmospheric conditions are predicted to occur in proximity to the combined solar power plant are stored in a database that is accessible to other components of the operations center. In step 1604 the operations center operates the concentrated solar power plant by a selected operation rule from the plurality of operational rules in accordance with a predicted atmospheric event. In step 1508 a learning system monitors a performance aspect of the concentrated solar power plant during its operation in accordance with the selected operational rule during the predicted atmospheric event. In step 1612 the learning system modifies the selected operational rule based on a learned behavior noted in response to the monitoring action. The process stops at step 1614.

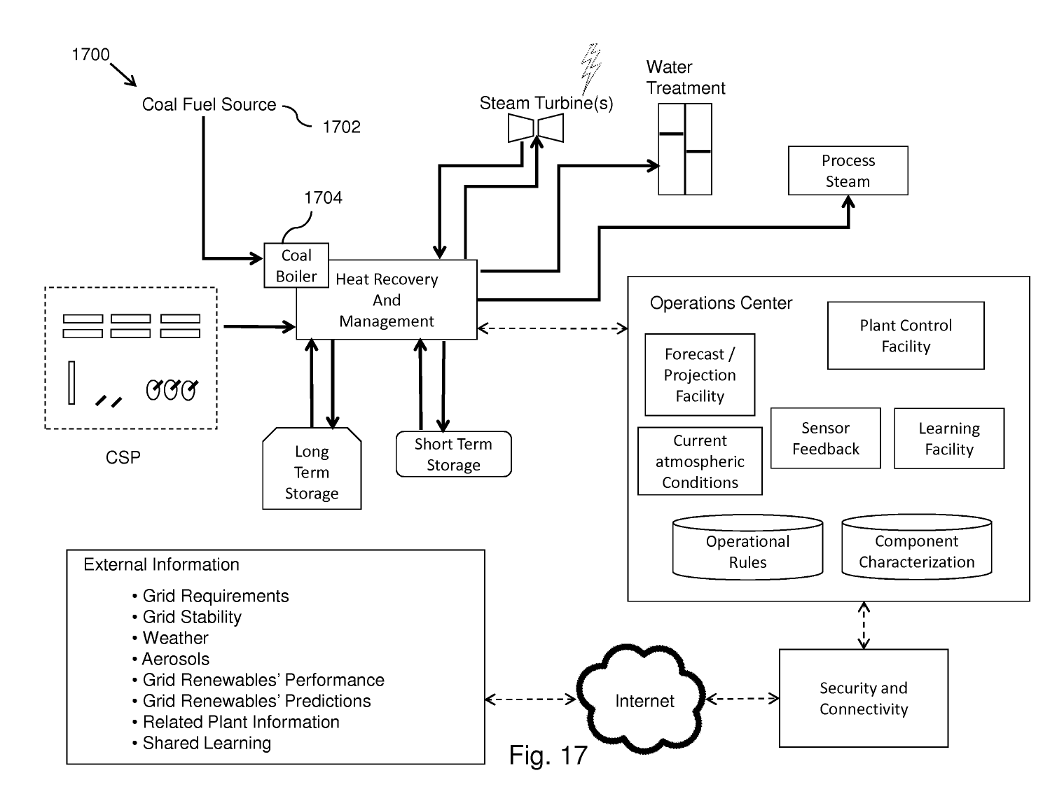

The control methods and systems described herein may alternatively be applied to operation of a coal-fired-solar power plant. In a coal-fired-solar power plant, coal is used as a fossil fuel source by the heat recovery and management facility to heat feedwater and produce steam for use by one or more steam turbine electricity generators. Rather than using waste heat from a gas turbine as depicted in FIG. 6, a coal-fired-solar power plant may include coal combustion systems to produce heat needed by the heat recovery and management facility to ensure sufficient pressurized steam is provided to the steam turbines. FIG. 17 depicts an alternate embodiment of the power plant control view depicted in FIG. 6 with the gas turbine replaced by a coal fuel source 1702 and coal-fired boiler 1704.

The coal-fired boiler 1704 may be controlled, sensed, and monitored as described herein for the purposes of efficiently operating a coal-fired-solar power plant 1700. Because electricity generation in a coal-fired-solar power plant comes from the steam turbines (because there is no gas turbine), the heat recovery and management facility is fully responsible for electricity production. Operational rules related to the coal supply 1702 and coal-fired boiler 1704 operation may be stored and accessed by the operations center. In an example, a coal fired boiler 1704 may have several coal combustion chambers for redundancy and maintenance purposes. Operational rules may relate to periodic maintenance scheduling so that a coal combustion chamber may be brought off-line for maintenance without interrupting the supply of steam to the steam turbines. Similarly, maintenance may be included in an operational rule or set of rules that directs portions of the operations center (e.g. plant control facility) to review atmospheric predictions prior to commencing execution of maintenance-related operational rules to avoid reduced coal-fired boiler 1704 output during a prolonged period of cloudy or stormy weather that may limit the thermal contribution of the concentrating solar field to steam production. Likewise, component characterization data in a coal-fired-solar power plant 1700 may include coal-fired boiler 1704 component thermal inertia data, coal 1702 quality data, and the like. An operations center, in cooperation with other elements of a coal-fired-solar power plant 1700, may monitor the operation of the coal-fired boiler(s) 1704 and related components to learn operational patterns that could be applied to facilitate maintaining a predetermined level of performance of the coal-fired-solar power plant 1700 during various weather-related conditions. As improvements in coal-fired combustion chamber technology and coal thermal contribution efficiency are made known, the operations center may apply these advances and improvements (e.g. by receiving updated operational rules or thermal inertia data through the internet) and monitor the operation of the coal-fired boilers 1704 under the updated operational rules. This may facilitate making adjustments in the updated operational rules based on the particular conditions (e.g. weather patterns) of the coal-fired-solar plant 1700.

Control of the coal-fired-solar power plant 1700 may also be similar for the elements that are common with the gas-turbine based hybrid fossil-fuel-solar power plant embodiment of FIG. 6. These elements may include, without limitation concentrating solar power facilities, long term storage, short term storage, steam turbine(s), water treatment, process steam, operations center elements, and the like. In an example, control of water treatment for removing brine from salty water to produce fresh water may be controlled in the coal-fired-solar power plant similarly to water treatment in a fossil-fuel-solar plant that includes a gas-turbine.

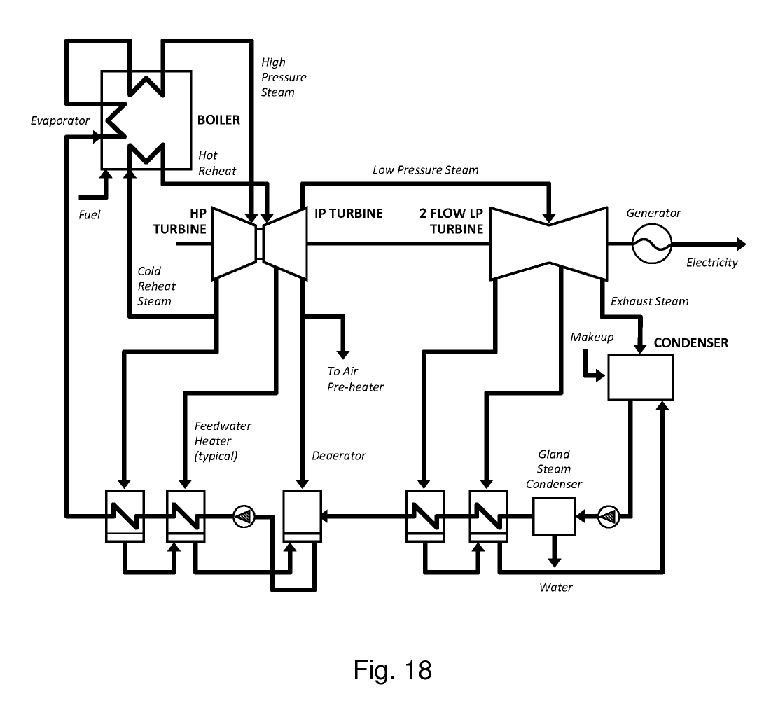

Control of a power plant as described herein may be applied to a variety of electricity generating power plants including integrated solar Rankine cycle plants and the like as depicted variously in FIGS. 18-20. A power plant as depicted in FIGS. 18-20 may be controlled in response to predicted atmospheric conditions using power plant component characterization information, such as thermal inertia. Such power plants may be alternatively be controlled using operational rules that may be based on predicted atmospheric conditions. In addition, a learning system may be used in the control of such a power plant, such as by modifying an operational rule based on behavior of the power plant learned through monitoring.

FIG. 18 depicts a Rankine steam cycle power plant that may be controlled as described herein to ensure that components used to operate the high pressure (HP) turbine, intermediate pressure (IP) turbine, and two low pressure (LP) turbines operate properly in response to a predicted atmospheric condition so that the plant continues to perform at a predefined level of output and/or efficiency.

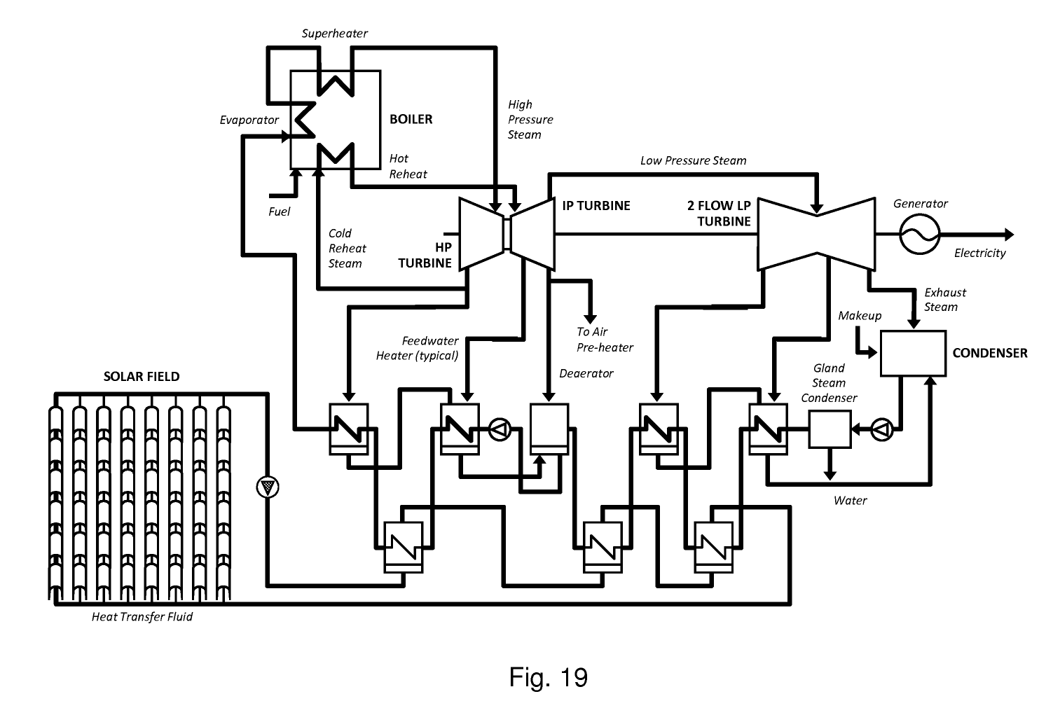

FIG. 19 depicts the power plant of FIG. 18 with the addition of a solar field and feedwater preheaters that are fed heat from the solar filed via a heat transfer liquid. Control of such a power plant may include learning through monitoring of the solar filed heat transfer process, component characterization information that may influence how an operational rule may be adjusted to ensure that the power plant is controlled to operate within a predefined operational range in response to an occurrence of a predicted atmospheric event.

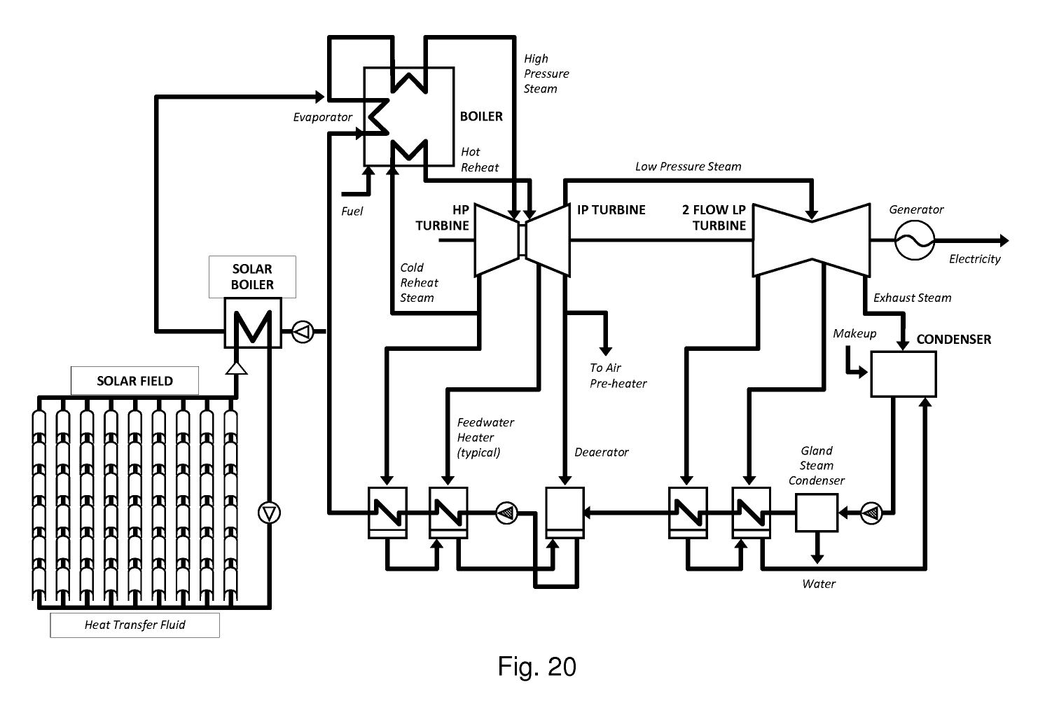

FIG. 20 depicts the power plant of FIG. 18 with the addition of a solar field and solar boiler, such as for supplemental steam generation. In the embodiment of FIG. 20, operational rules may be configured to attempt to keep the solar field heat contribution above a minimum level during an occurrence of a predicted atmospheric event. The solar field heat contribution may be monitored by a learning system that may make adjustments to operational rules related to the predicted atmospheric event to further improve the overall power plant electricity generating performance.

In order to better control temperature, pressure, and/or flow of the feedwater in the solar feedwater heating facility and throughout the hybrid power plant system, the flow of feedwater and/or steam may be controlled and/or moderated by one or more controllable valves and/or pumps. The controllable valve and/or pumps may be controlled by the Operations Center depicted in FIG. 6. Flow control valves may facilitate control of the hybrid power plant, such as by regulating the flow or pressure of the working fluid, and the pumps may control the circulation of the working fluid either in water or steam form. Pumps for circulating the feedwater may be water pumps such as direct lift pumps, displacement pumps, velocity pumps, buoyancy pumps, ‘gravity pumps, and the like.

In order to regulate the temperature, pressure and or flow of the system, the flow of steam into the direct solar steam superheater facility may be controlled and/or moderated by one or more control valves. These control valves may be employed at the outlet of the HRSG evaporator and may modulate the flow of steam to the direct solar steam superheater facility as depicted in FIG. 4.

An Operations Center may be provided to facilitate monitoring and controlling the operation of the one or more adjustable features of the power plant, such as, working fluid valves, solar trough reflector position motors, fuel usage valves, turbine control, weather response systems, preventive maintenance functions, and the like. An interface associated with the operations center may facilitate sensing and controlling temperature, pressure, and flow of water, steam, and/or heat transfer fluid.

Such an interface may include a plurality of features for monitoring and responding to sensors distributed throughout the power plant and for adjusting a plurality of control valves distributed throughout the power plant. Some such examples may include valves controlling flow from the solar field to the STG, from the HSRG to the STG, from the HSRG to the solar field, and the like. The control valves and sensors may be connected to the operations center by one or more interface cables and/or via wireless communication. It may be noted that the control valves described herein are merely exemplary. Furthermore, any number of valves and/or sensors may be configured in various configurations that facilitate operation of the power plant over a wide range of environmental, mechanical, design, human error, and other factors. In addition to flow control valves, sensors and control aspects of the invention may be applied to parabolic trough alignment/positioning, weather assessment, response measures, and the like. The operations center interface may include a user interface to help manage a control facility, a temperature display facility, a pressure display facility, a solar radiation monitoring facility, an interface cable, and the like.

In embodiments, one or more flow control valves may be provided to regulate the flow of steam at the discharge outlet of the direct solar steam superheater facility. Referring again to FIG. 4, by reducing the flow of steam at the control valve X at the outlet of the direct solar steam superheater, the direct solar steam superheater facility may slow the flow of steam through the direct solar steam superheater facility thereby raising the steam temperature. In another example, the control valve Q may be adjusted to increase the flow of steam from the HRSG evaporator, thereby increasing the flow of the steam through the direct solar steam superheater facility. In this case, a comparatively large amount of steam may pass through the direct solar steam superheater facility in any given period of time thereby reducing the steam outlet temperature.

In embodiments, one or more valves provided at the outlet of the HRSG superheaters may be utilized to control the temperature of the superheated steam provided to the STG. For example, the control flow valve Y may be set at a particular pressure so as to regulate the flow of the steam. This may result in reduced flow of superheated steam out of the HRSG superheater, which may lead to increase in temperature of the steam due to the fact that the reduced flow allows additional time for the steam to be superheated. Alternatively, a water feed may be introduced at the outlet of the HRSG or direct solar steam superheater facility to modulate the temperature. The water feed may control the temperature of the steam by introducing hot water. The hot water may absorb a part of the superheated steam to reduce temperature of the first superheated steam. In other embodiments, the temperature of the superheated steam may be controlled using one or more water feeds, one or more control flow valves at the discharge outlet of the direct solar steam superheater facility, and one or more control valves at the outlet of the evaporator of the HRSG facility. For example, a water feed may be used in conjunction with the one or more control valves at the discharge outlet of the direct solar steam superheater facility to control the temperature of the first superheated steam. In another example, a water feed may be used in conjunction with one or more control flow valves at the outlet of the superheaters to control the temperature of the first superheated steam. In yet another example, one or more control valves at the discharge outlet of the direct solar steam superheater facility and one or more control valves at the outlet of the superheaters may be utilized for regulating the temperature of the superheated steam.

A portion of the plurality of control valves, as mentioned herein above, may be used for regulating the flow of fluids in the pipelines. For example, referring to FIG. 4, a control valve controlling flow from the HRSG to the solar field and/or a valve controlling flow from the HSRG to the STG may be an automated high pressure ball valve that may be used with either of the superheaters in the HRSG for regulating the flow of the working fluid, thereby facilitating adjustment of the pressure and/or the temperature of the working fluid which may include water, low pressure steam, superheated steam, high pressure steam or any other working fluid.

In embodiments, the working fluid valves may be used with an outlet of the water supply system to affect feedwater flow control. The feedwater flow control may be particularly beneficial during startup. Feedwater flow control may also be useful in regulating minimum feedwater volumes. In an example of startup or shutdown, the feedwater control may be restricted by feedwater flow valves operating near a closed valve position.

In addition to the ball valve embodiment described herein, valve types may include butterfly, angle, globe, gate, check, and the like.

Examples of a control valve may include a check valve that may be used with a hybrid power plant power plant. The check valve may also be known as a clack valve, non-return valve, or one-way valve that allows flow of fluid in one direction only. The check valve may include one port for fluid to enter and the other port for fluid to leave. Check valves may be beneficial in preventing higher pressures in downstream portions of the working fluid pipelines from kicking back to lower pressure portions. In an example, a check valve may be placed between the outlet of the HRSG and the inlet of the solar field so that water heated in the solar field, which may have an increase in pressure as a result of heating, does not backup into the HRSG. Further, check valves may operate in manual or automatic computer controlled mode.

The sensing and control facilities of the invention may include a solar field radiation monitoring facility and a control facility. Such a facility may provide support for monitoring and controlling the amount of solar radiation that may be transferred from the parabolic troughs to the fluid in the conduit. One technique for controlling and/or optimizing the amount of solar radiation transferred is to vary the alignment of the parabolic troughs with respect to the sun, the conduit, or both. By changing the alignment of the troughs, the total amount of solar radiation that may be collected for heating the working fluid or heat transfer fluid may be increased, thereby increasing the efficiency of the hybrid combined cycle power generation plant. In addition, the solar radiation monitoring facility may be configured to control the flow of water or heat transfer fluid in the conduit passing through parabolic troughs. For example, one or more sensors may determine the direction of maximum solar radiation. The one or more sensors may send corresponding signals to the control system and the control system may align the parabolic troughs accordingly for capturing the intense solar radiation. In another example, one or more sensors may determine the concentration of solar radiation in each of a plurality of solar troughs and accordingly modulate the flow of working fluid and/or heat transfer fluid through the conduits associated with the monitored solar troughs.

In embodiments, the operations center interface may include an interface to assess weather conditions. For example, a sensor may be configured to monitor the weather conditions, including wind speed, amount of sunlight, humidity and the like, for various purposes such as for changing the orientation of the parabolic troughs or other solar receivers. An external interface, including a cellular, satellite, or other electronic communication interface, may provide forecasted weather conditions for the coming days. This information may be stored in a database to facilitate planned control of the operation of the hybrid combined cycle power generation plant. In embodiments, data may be collected from a meteorological source, such as the national weather service. For example, the meteorological data may include a forecast of heavy rains, cloudy weather, and the like for the next day. Based on such data, in absence of intense solar radiations, generation of steam from other resources may be planned in advance. The control unit of the power plant may take substantive actions and may generate heat from other fuel gases.

As mentioned herein, the power plant may be equipped with one or more sensors which may detect local weather conditions. The sensors may be used to automate the operation of the power plant by providing signals corresponding to the weather conditions to a control system of the power plant that may suitably react to the signals. For example, when a sensor detects a dust storm, the sensor may send a signal to the control system. The control system may in turn automatically close a dust shield Likewise, the sensors may facilitate to reduce weather induced damages to the power plant by adjusting resources to protect wind sensitive equipment. In an embodiment, the sensors may detect the humidity and barometric pressure. An increase in humidity and/or a decrease in pressure may be present due to clouds and other weather conditions. In response to the signals from the sensors, the control system may increase the fuel flow to the gas turbine or may activate unused portions of the solar field for increasing the amount of heat generated to compensate for the limited sunlight that may result from cloud cover.

The Operations Center may include one or more temperature sensors, pressure sensors or some other type of sensors for controlling and/or modulating the flow of steam from the direct solar superheater facility. In embodiments, temperature sensors may be used for measuring, controlling and recording temperatures. The temperature sensors may be available in various types such as J type, L type, and the like. These sensors may continuously monitor the pressure and/or temperature of the steam to modulate the pressure at one or more control valves. Control valves may be used to control conditions such as flow, pressure, temperature, and liquid level by fully or partially opening or closing in response to signals received from sensors. The sensors may monitor changes during such conditions. For example, the temperature and/or pressure at a control valve that controls flow from the solar field to the STG, a control valve that controls flow from the HSRG to the STG, and a control valve that controls flow from the HSRG to the solar field, may be monitored by the Operations Center using sensors associated with the valves. A fall in pressure at the control valve controlling flow from the solar field to the STG may be detected by the corresponding temperature and/or pressure sensor. This may result in an adjustment of the control valve regulating flow from the HSRG to the STG and the control valve regulating flow from the HSRG to the solar field for maintaining the required pressure at the steam turbine. In another example, the control valve regulating flow from the solar field to the STG and the control valve regulating flow from the HSRG to the STG may be monitored by the sensors associated with them and a fall in pressure at the control valve regulating flow from the solar field to the STG may be detected. The control valve regulating flow from the HSRG to the STG may be adjusted to compensate for the decrease in pressure. Additionally, the control valve regulating flow from the solar field to the STG, the control valve regulating flow from the HSRG to the STG, and the control valve regulating flow from the HSRG to the solar field may be controlled between a minimum point and a maximum point. The minimum point may allow a specified flow of steam through the control valves. Similarly, the control valves may operate at a maximum point thereby allowing a full flow.

Pressure sensors may be classified in terms of pressure ranges they measure, temperature ranges of operation, the type of pressure they measure, and the like. Based on pressure types, the pressure sensors may be classified as absolute pressure sensors for measuring pressure relative to a perfect vacuum. Further, a gauge pressure sensor may be used for measuring the pressure relative to a given atmospheric pressure at a given location. Furthermore, a sealed pressure sensor may be similar to a gauge pressure sensor except for the difference that the sealed pressure sensor may be previously calibrated by manufacturers to measure pressure relative to sea level pressure. In embodiments, the sensors for measuring pressure less than the atmospheric pressure at a given location may be categorized as vacuum pressure sensors. Also, a differential pressure sensor may measure the difference between two or more pressures introduced as inputs to a sensing unit. For example, while measuring the pressure drop across an oil filter, a differential pressure sensor may be used. Moreover, these sensors may also be used for measuring flow or level in pressurized vessels.

Sensors and/or control valves may be installed at various locations including the outlet of the superheater 1 and the superheater 2, the inlet and the outlet of the evaporator facility, the inlet and the outlet of the economizer, and the inlet and the outlet of the direct solar feedwater facility. For example and as described below, the sensor and the control value combination may control the flow of water and/or steam at the superheater 1 and the superheater 2. Likewise, in another example, the parabolic trough may have control valves and sensors to modulate the flow of water to increase or decrease the generation of steam. Additionally, the user interface may be attached with a computing device for storing information corresponding to each of the sensors and/or the control valves. In embodiments, the sensors and/or valves may be integrated in a single unit and installed within a specified distance of the facility to be monitored. In embodiments, the control valve and the sensors may include a wireless facility that may send information to the operations center wirelessly. The data collected for one or more sensors may be analyzed using a computer program for operating the hybrid combined cycle power generation plant in optimum condition. In embodiments, the optimum condition may be the condition when the hybrid combined cycle power generation plant utilizes solar radiation for best efficiency.

The operations center may include a processor that may execute algorithms that may optimize the operation of the hybrid combined cycle power generation plant, such as, by using the legacy sense and control data stored in a database that is accessible to the processor. For example, information stored in the database may allow the operations center to identify emergency conditions, optimum condition for operation under different weather conditions, and the like. Likewise, information collected from sensors may be utilized for planned control of the opening and closing of one or more control valves in order to keep the operations of the hybrid combined cycle power generation plant at an optimum level. In embodiments, information collected from various sensors may be utilized for deriving initial or baseline parameters for operating under various pressure and temperature conditions. For example, the parabolic troughs in the solar field may be automatically adjusted based on historical sensing data to continuously follow the sun throughout the seasonal changes to maintain a preferred pressure so as to generate a steady flow of steam.

The circulation of feedwater in the direct solar feedwater heating facility and the supply of feedwater to the evaporator facility may be controlled by one or more flow control valves and/or sensors. The one or more control valves may be located between the economizer and the evaporator, the economizer and the direct solar feedwater facility, and/or the evaporator and the output of the direct solar feedwater facility. The sensors may be devices that measure physical quantities and convert them into signals that can be read by an observer, and/or an instrument and the like. The physical quantities may include temperature and/or pressure and the like. In an exemplary embodiment, the one or more sensors may be attached to a Operations Center (not shown), which may receive feedback of temperature and/or pressure at each of the control valves. A timer associated with the Operations Center may continuously, or at fixed time intervals, monitor the temperature of the hot water and regulate it according to the preset temperature. For example, the temperature at the discharge of the direct solar feedwater facility may be recorded by the associated sensor, compared with the predefined value, and regulated accordingly to increase or decrease of the flow. In another example, the recorded value may be compared with the preset value to regulate the flow of hot water at the control valve located between the economizer and the direct solar feedwater facility. It may be noted that one or more control valves may operate between a minimum point and a maximum point. At the minimum point, a moderate flow of hot water may flow through the control valve. Similarly, the maximum point may correspond to full flow.

Sensors and/or control features may be associated with the gas turbine portion of the power plant. To prevent undesirable buildup of residual combustible gas, a gas sensor may detect the flow of residual and/or other gases so that an operator and/or an automated control facility may take corrective action to eliminate the presence of these gases.

Some implementations of a combined cycle solar power plant may include the use of molten salts as a heat transfer fluid. Generally, molten salt applications require that the heat transfer fluid remain above a minimum temperature threshold so that the salts do not solidify. Sensors may be installed in association with the parabolic troughs of a solar filed that uses molten salts to monitor the temperature of heat transfer fluid. If a hybrid power plant or hybrid combined cycle power plant is installed in a desert region, the ambient temperature can be substantially lower at night than during the day. Therefore, by continuously monitoring the temperature, a power plant control facility or an operator may adjust the operation of the power plant that uses molten salts to avoid allowing the temperature to decrease below the molten salt threshold.

An hybrid power plant generation plant may be operated in a variety of different modes including an offline (e.g. islanded) mode, base load, peaking, wind down mode, and the like. The control and sensing capabilities of the invention may provide sufficient control over the power plant to facilitate operation of the power plant in any of these modes.

It may be desirable to control the electrical energy output of a power plant. The Operations Center may control the output by controlling the flow of steam into the steam generator. Control valves may be provided at the outlet of the superheaters in the HRSG and the direct solar superheater field (if one is included) to control the amount of steam passing into the steam turbine. Such control valves may be regulated through the use of sensors. It may be noted that simply reducing an outflow of a superheater or a direct solar superheater may result in the substantially increased temperature and/or pressure of the working fluid in the superheater. If this result is not desired, countermeasures may be necessary. For example, by reducing the flow of steam at a control valve regulating the flow from the solar field to the STG, at the outlet of the direct solar steam superheater, the reduced flow of working fluid through the direct solar steam superheater facility may result in raising the outlet temperature. In another example, with a control valve regulating the flow from the solar field to the STG wide open, a control valve regulating flow from the HSRG to the solar field may be adjusted to increase the flow of steam from the evaporator, and thereby increase the flow of the steam through the direct solar steam superheater facility and reduce the direct solar superheater outlet temperature. Further, by controlling the alignment of the parabolic troughs of the solar plant, the temperature of the working fluid in the solar plant may be maintained. For example, the parabolic troughs may be aligned such that the solar radiations incident on the parabolic troughs may be of higher intensity thereby heating the fluid in an effective manner. These examples illustrate a few of the many options available for the deployment and use of sensors and control valves for monitoring and controlling the operation of such a power plant.

In addition to measuring various points and features of the power plant, the one or more sensors may provide feedback to the control facility of the temperature and/or pressure at each of the control valves. For example, when the temperature and/or pressure at any of the control valves described above vary from an expected value, the variation may indicate that the power plant is deviating from a desired electrical energy output. Because temperatures and pressures at the various control valves may vary substantially from an initial startup stage of the power plant to an optimum working level, the one or more control valves may allow changes in the flow of steam or other working fluid through various parts of the power plant based on the operating mode. To adjust for the various operating modes, it may be necessary to combine certain flows that normally do not combine. In an example, the temperature of the superheated steam may be controlled by using introducing feedwater. Feedwater may be introduced through one or more control valves at the discharge outlet of the direct solar steam superheater facility to control the temperature of the first superheated steam. In another example, feedwater may be used in conjunction with the one or more control flow valves at the outlet of the superheaters to control the temperature of this superheated steam.

Sensors and control features may be located within and among the key functional blocks of the hybrid power plant. Various examples of controlling the flow of steam and working fluid related to superheating are described above. Various examples of controlling the parabolic troughs of a solar field are described above. Below are several additional examples of sensors and control features that may be associated with a hybrid power plant as depicted in the figures.

Sensor and control features that may be associated with a Operations Center of the invention may also be associated with a water supply system of the invention as depicted in FIGS. 1-3. Sensors and control features may be applied to the working fluid provided by the condensate pump. The sensors may monitor the volume, pressure, temperature, density, and other aspects of the working fluid as it enters the water supply system. Control valves and control features may be used to manage the flow of the working fluid into the water supply system. Management of the flow of the working fluid that is pumped into the water supply system may be dependent on information provided by various other sensors associated with the water supply system and/or other functional blocks. In an example, sensors that detect the amount of condensation water being captured by the Water Reclaim Exchanger may impact how the in-flow is managed. In another example, the sensors and control features may facilitate identifying the condensate pump. Based on the results, taking an action such as operating the pump in variable speed mode may be executed by the control facility. Operating the pump in variable speed drive mode may reduce the consumption of electricity needed to operate the pump for inflow to the water supply system, thereby improving energy utilization. For example, reducing the pump speed by 20% can result in a 50% reduction in energy consumed. Thus, using a variable speed drive pump operation may promote process control and energy conservation in the water supply system. In addition, the use of control features to manage the condensate pump may offer other benefits such as but not limited to pre-blockage detection, intelligent flushing cycles, periodic efficiency testing and pump operation data storage and the like. The control facility may access a database that may be configured to record the variable speed pump drive data. This data may be utilized to identify optimum variable speed drive at various power plant and water supply system operating modes, such as at a particular pressure and/or temperature of condensate water. Moreover, use of variable speed drive operation may provide other advantages such as a reduction in speed of a pump which may prolong pump operational life and reduce wear and tear on the pump.

Sensor and control features that may be associated with the water supply system may further be associated with the condensate cooler and the air-cooled chiller. The condensate cooler may be provided with temperature and pressure sensors for measuring the drop in pressure and temperature of the water entering the condensate cooler. For example, if the temperature sensors of the condensate cooler detect that the temperature of the water has not reached the desired temperature, the sensors may send a signal that may be interpreted by a control facility to adjust control valves to direct the flow of water to the air-cooled chiller. Likewise, the water may flow to the air-cooled chiller until the water entering the water supply system acquires the desired temperature prior to reaching the condensate cooler. Thereafter, water flow may be channeled to the water reclaim exchanger without continued use of the air-cooled chiller and/or the condensate cooler. Based on the temperature of the water as it approaches the condensate cooler, a portion of the water may bypass the condensate cooler. The length of conduit in the condensate cooler may be adjusted through the use of a valve that optionally extends the time that the condensate water passes through the condensate cooler. With an increased path length for the condensate water in the condensate cooler, the condensate exiting the cooler may attain a lower temperature. Further, the control valves coupled to the air-cooled chiller may be adjusted to regulate the flow of ambient air in the air-cooled chiller, such as for reducing the temperature of the water therein. Such an adjustment may be based on data retrieved from a condensate temperature sensor. The sensors employed with the air-cooled chiller may facilitate controlling the condensate water that is used by the water supply system.

The sensors and controls may supply data that is associated with the condensate cooler and/or the air-cooled chiller to be stored in a database which may include legacy data that corresponds to the condensate cooler sensors, the air-cooled chiller sensors, the condensate water sensors, the air quality sensors, the position of the control valves, and the like. This information may be utilized by the control facility to ensure that the condensate water exiting the condensate cooler meets the requirements for efficient water reclamation.

As mentioned above, the sensor and control features may monitor the air passing through the air-cooled chiller. Depending upon the measures and calculated characteristics of the air, such as humidity, air temperature, density of air, the constituents of air, and the like, the flow of air passing through the air-cooler chiller may be modulated. For example, if the air is high in humidity, the rate of air flow may be increased or the rate of water passing through the condensate cooler may be reduced. It is noted that one or more elements, such as a condensate cooler, air-cooled chiller, and the like, may be duplicated within the water supply system for failsafe and/or capacity expansion.

Further, sensors associated with the water supply system may determine the hardness of the feedwater. If the hardness of the feedwater is found to be above a particular limit, the control system may reduce the flow of water until the water attains a permissible hardness level. In embodiments, the sensor may prompt the control unit to take action for correcting the hardness of the water to a permissible limit.

In yet another example, the feedwater entering the condensate cooler may have a high/low pH value, as the feedwater may contain impurities dissolved therein. The sensors may detect the pH value of the feedwater. This sensed pH value may be provided to a control facility that may display it on a user interface and/or send an alert by other means. Once an undesired pH level is detected, a signal may be sent to a facility that may release an appropriate amount of buffer to adjust the pH to the desired level.

The water in the water treatment system may be continuously monitored using one or more sensors to identify the concentration of extraneous gasses in it. This may be useful for safeguarding the equipment in the power generation unit such as turbines, flow pipes and other equipment.

The control features associated with the water supply system may control the startup and operation of the water supply system. Such control may be based on sensor data that is provided from sensors that monitor other portions of the power plant. In an example, the water supply system control features may hold off activating the water supply system until sensors in the power plant indicate that the plant is operating at higher than a minimum operating threshold. In this way, reclaiming water from the exhaust gasses may be based on the power plant reaching a minimum output capacity.

Sensor and control features that may be associated with the water supply system may be further associated with the water reclaim exchanger. The water reclaim exchanger may be used for collecting the water from the exhaust flow through condensation. The water reclaim exchanger may include sensors that may determine various factors effecting the operation of the water reclaim exchanger. For example, the sensors may detect the presence of humidity in the ambient air. Due to the use of the humid air during the combustion events, the water reclaim exchanger may be able to extract more water from the exhaust gases, thereby increasing the rate of water reclamation. This variance in water reclaim rate may be detected by one or more sensors. By combining the data of the ambient air humidity with the reclaimed water rate data, the control facilities may determine a relationship between them.

The sensors may also determine the quality of surface of the condensation conduit. The water reclaim exchanger and/or the condensation conduit may be coated with an anti-rust material. The antirust coating may allow the condenser to operate even with hard water. If the sensors detect that the condensation surfaces are developing residual buildup, the rate of heat transfer from the exhaust gas to the feedwater in the conduit will be reduced. By detecting this increased difference in temperatures, an operator may be assigned to take corrective action, such as cleaning the condensation surfaces in the water reclaim exchanger.

Sensor and control features that may be associated with the water supply system may be further associated with the water treatment system that treats the water collected by the water reclaim exchanger. Treating the reclaimed water may involve several automatable steps that can be determined based on the condition, amount, flow rate, and demand for the reclaimed water. Each of these factors, and others related to water treatment, may be measured with various sensors. These measurements maybe analyzed by a computing facility that may direct the control features to perform the necessary treatment operations. In an example, a reverse osmosis filter needs, from time to time, a supply of water to flush the filter. The control facility may determine to execute the flushing operation when one or more sensors detect that the flow of reclaimed water is high. In another example, if a sensor that detects water use (e.g. for facilitating the replenishment of feedwater in the power plant) indicates an increasing demand, the control facility may increase the amount of water provided for replenishment. Sensors related to the water reclamation, treatment, consumption, and demand thereof may be associated with valves and other control features so that the operation of the valves or control features may be monitored.

Sensor and control features that may be associated with the water supply system may further be associated with the water storage tank. For example, the sensor facility associated with the water treatment system may determine when the water collected from the water reclaim exchanger has been completely treated such that the water is free from any impurities. The sensors may thereby modulate the corresponding control valves to allow the passage of the treated water in the water storage tank. The water storage tank may store the treated water for later use.

Sensor and control features that may be associated with the water supply system may further be associated with the make-up pump. The make-up pump may be adapted for forwarding the treated water to a condenser that reintroduces the reclaimed water into the feedwater system. In an example, one or more sensors may determine if the make-up pump is active. If it is not, then the water in the water storage tank may be provided to other uses as described herein.

In addition, sensor and control features that may be associated with a Operations Center of the invention may be associated with the steam turbine generator, the air-cooled condenser, the solar heat exchange system, including the solar boiler feed pump, the solar economizer, the solar boiler, the solar superheater and the like, the solar field of parabolic troughs, a solar tower (not shown), the combustion turbine generator, the heat recovery steam generator, the solar field for producing supplemental superheated steam, the solar field for producing near saturation temperature working fluid, and the like. Likewise, the sensors and control features may be associated with managing the flow of working fluids, thermal transfer fluids, boiler blow down waste and venting, combustion fuel consumption by the combustion turbine generator and/or the heat recovery steam generator, electricity production, any or all of the interfaces between and among the various functional blocks, and the like.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. [This section seems incomplete. What about GPRS, 3G, EVDO and other networks types. Also the list of network hardware/components seems incomplete. Please research and add to this.]

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method of controlling a concentrated solar power (CSP) plant, the method comprising:
storing a thermal inertia characteristic relating to each of a plurality of thermal energy processing components used in the CSP plant in a database;
receiving atmospheric condition prediction information relating to an atmospheric event, the atmospheric condition prediction information indicating that at least one of the plurality of thermal energy processing components requires adjustment such that the CSP plant performs within pre-determined requirements during the atmospheric event;
retrieving a thermal inertia characteristic relating to the at least one of the plurality of thermal energy processing components from the database; and
causing the at least one of the plurality of thermal energy processing components to be adjusted based on the retrieved thermal inertia characteristic at a point in time that enables the CSP plant to operate within the pre-determined requirements during the atmospheric event.
